(19) United States
(12) Patent Application Publication
(10) Pub. No.: US 2025/0388093 A1
(43) Pub. Date: Dec. 25, 2025

(54) METHOD FOR DYNAMIC TORQUE OUTPUT ASSIST AND REGENERATIVE BRAKING OF A TRAILER

(71) Applicant: Range Energy Inc., Mountain View, CA (US)

(72) Inventors: Ryan Flatland, San Carlos, CA (US); Theodore DeGuzman, Palo Alto, CA (US); Collin MacGregor, Redwood City,, CA (US); Ali Javidan, Sunnyvale, CA (US); Kyle Foley, Half Moon Bay, CA (US); Bryan Booth, San Mateo, CA (US); Brinton Mooberry, Sunnyvale, CA (US)

(21) Appl. No.: 19/244,812

(22) Filed: Jun. 20, 2025

Related U.S. Application Data
(60) Provisional application No. 63/662,336, filed on Jun. 20, 2024.
(60) Provisional application No. 63/766,602, filed on Mar. 4, 2025.

(51) Int. Cl. B60L 15/20; B60L 3/10; B60L 7/18; B60L 7/26; B60L 50/60; B60L 58/15; B62D 59/04

(52) U.S. Cl. CPC B60L 15/20; B60L 3/108; B60L 7/18; B60L 7/26; B60L 50/60; B60L 58/15; B62D 59/04; B60L 2200/28; B60L 2240/12; B60L 2240/16; B60L 2240/18; B60L 2240/22; B60L 2240/26; B60L 2240/40; B60L 2240/423; B60L 2240/461; B60L 2240/54; B60L 2240/60; B60L 2240/642; B60L 2240/647; B60L 2260/24

(57) ABSTRACT

One variation of a method includes: detecting a deceleration of a trailer during a first time period; detecting an incline angle of the trailer during the first time period; estimating a passive deceleration component of the deceleration based on the incline angle; and calculating a difference between the passive deceleration component and the deceleration. This variation of the method further includes, in response to the passive deceleration component exceeding the deceleration: interpreting an intent at a tow vehicle, coupled to the trailer, to accelerate; and increasing torque output of the motor proportional to the difference. This variation of the method further includes, in response to the deceleration exceeding the passive deceleration component: interpreting the intent at the tow vehicle to decelerate; and increasing regenerative braking of the motor proportional to the difference between the passive deceleration component and the deceleration.

### CROSS-REFERENCE TO RELATED APPLICATIONS

This Application claims the benefit of U.S. Provisional Application No. 63/766,602, filed on 4 Mar. 2025, and U.S. Provisional Application No. 63/662,336, filed on 20 Jun. 2024, each of which is incorporated in its entirety by this reference.

This Application is related to U.S. application Ser. No. 18/941,813, filed on 8 Nov. 2024, and U.S. application Ser. No. 18/388,474, filed on 9 Nov. 2023, each of which is incorporated in its entirety by this reference.

### TECHNICAL FIELD

This invention relates generally to the field of overland trucking and, more specifically, to a new and useful method for dynamic torque output assist and regenerative braking of a trailer in the field of overland trucking.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method;

FIGS. 5A and 5B are flowchart representations of one variation of the method;

FIG. 6 is a flowchart representation of one variation of the method;

FIGS. 7A and 7B are flowchart representations of one variation of the method; and

FIGS. 8A, 8B, 8C and 8D are schematic representations of a system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

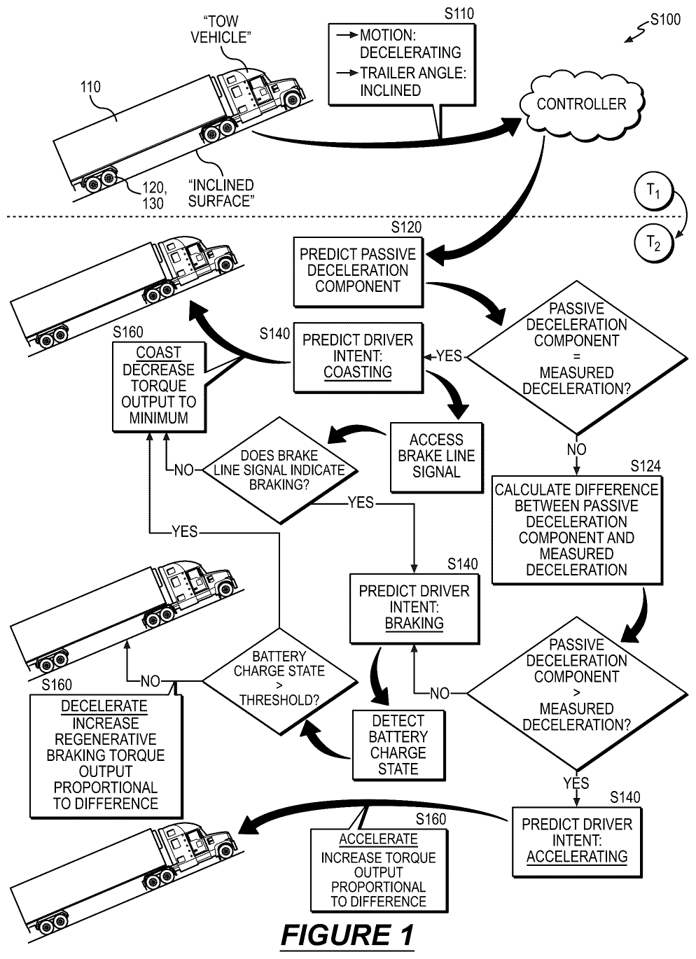

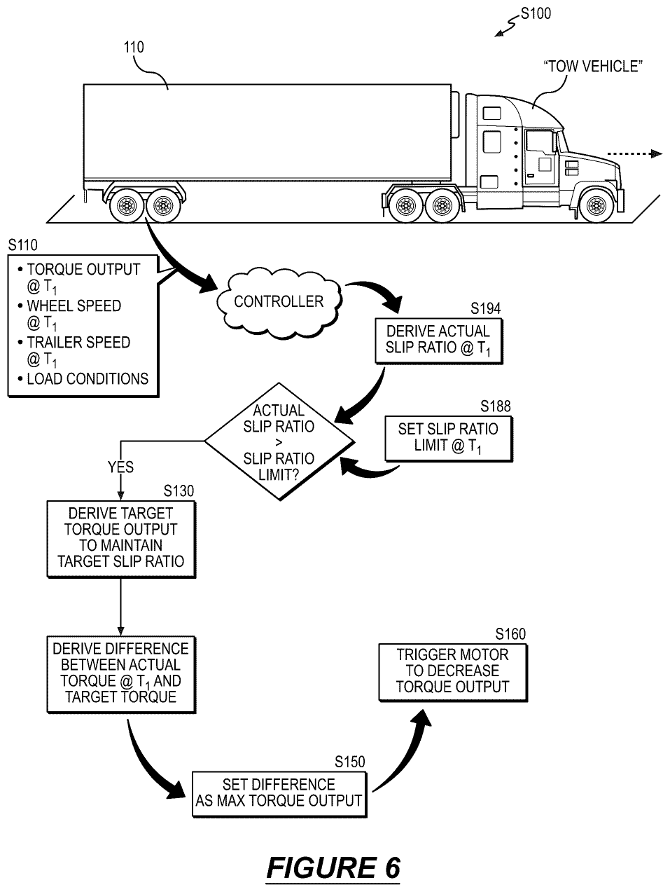

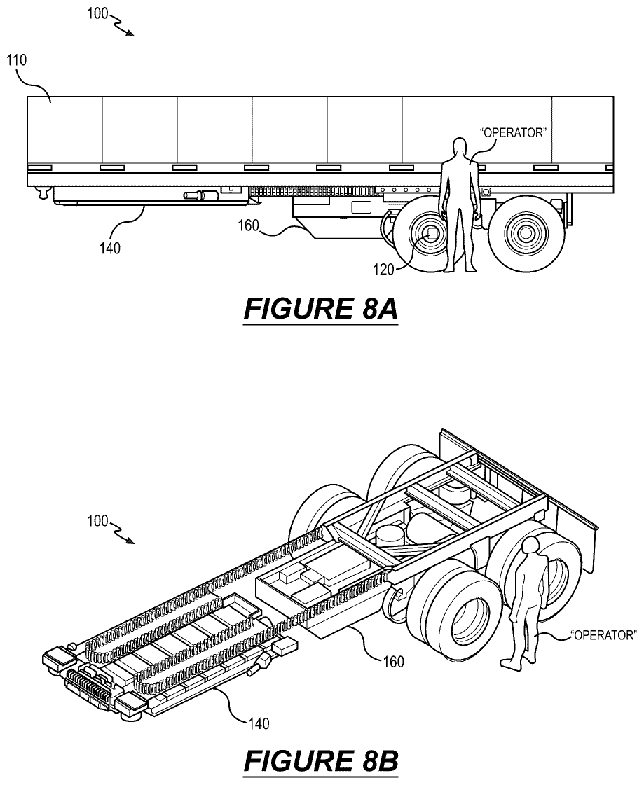

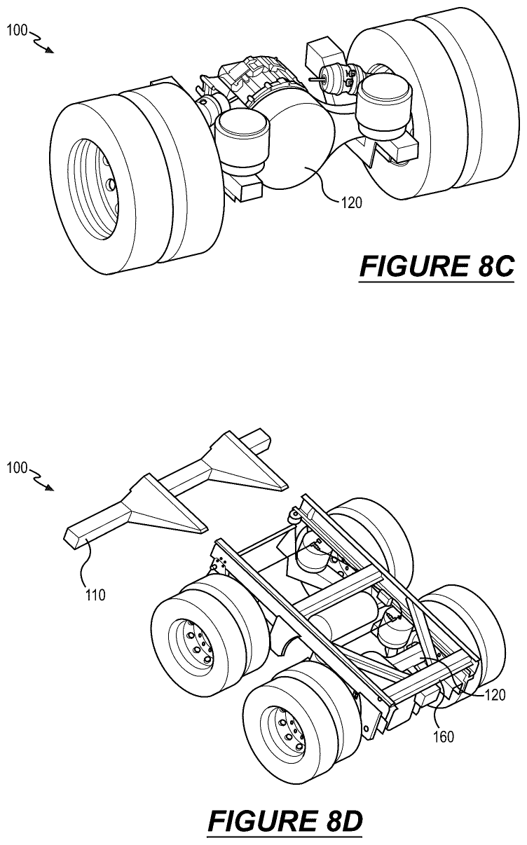

As shown in FIGS. 1-6, and 8A-8D, a system 100 includes: a driven axle 120 configured to install on a trailer 110; a motor 130 coupled to the driven axle 120; a battery assembly 140; and a controller. The motor 130 is configured to: output torque to the driven axle 120; and regeneratively brake the driven axle 120. The battery assembly 140 configured to: install on the trailer 110; supply electrical energy to the motor 130 to drive the driven axle 120; and receive electrical energy from the motor 130 to recharge the battery assembly 140 during regenerative braking of the driven axle 120 by the motor 130. The controller is configured to: detect a deceleration of the trailer 110; detect an incline angle of the trailer 110; estimate a passive deceleration component of the deceleration based on the incline angle; calculate a difference between the passive deceleration component and the deceleration; and modulate torque output of the motor 130 proportional to the difference.

### 2. Method

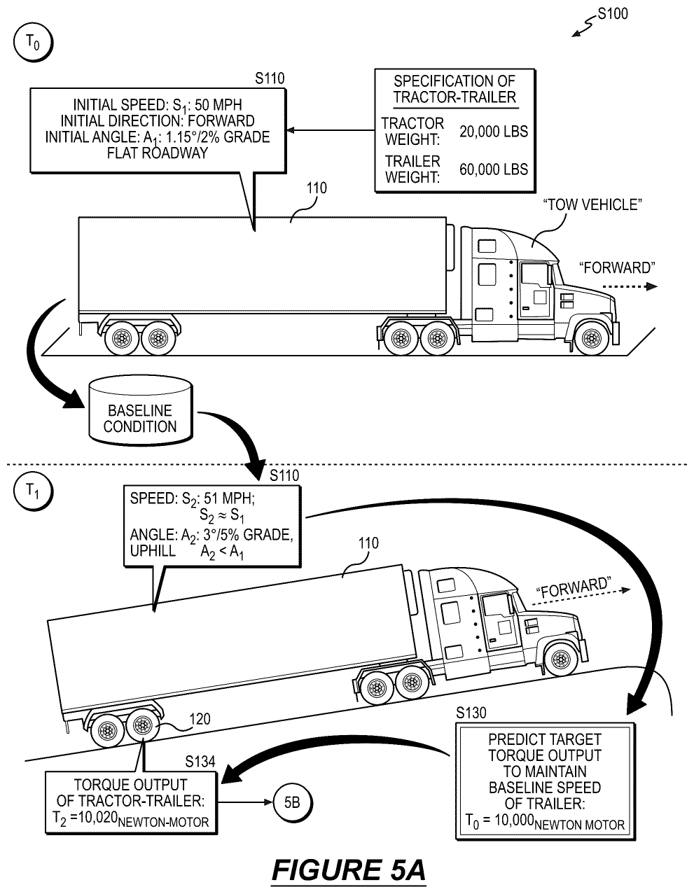

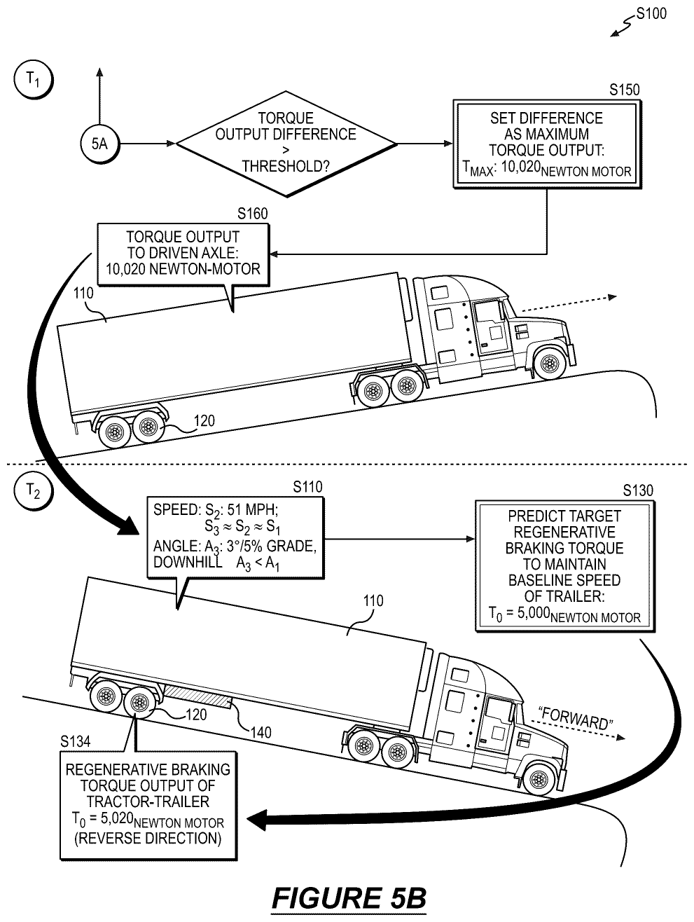

As shown in FIGS. 5A and 5B, a method S100 includes, during a first time period: detecting a first speed of a trailer 110, a first direction of motion of the trailer 110, and a first incline angle of the trailer 110 in Block S110. The method S100 further includes, during a second time period: detecting a second speed of the trailer 110, a second direction of motion corresponding to the first direction of motion of the trailer 110, and a second incline angle of the trailer 110 in Block S110.

The method S100 also includes: detecting a change from the first time period to the second time period based on the first incline angle and the second incline angle; estimating a target torque output, in the first direction of motion, to reduce a difference between the first speed and the second speed over the change in incline angle from the first time period to the second time period in Block S130; and accessing a first torque output (e.g., a current torque output, an actual torque output) by a motor 130, arranged in a bogie 160 located below a floor of the trailer 110, in the first direction of motion from the first time period to the second time period in Block S134.

The method S100 further includes, in response the first torque output exceeding the target torque output: interpreting an intent at a tow vehicle, coupled to the trailer 110, to accelerate in Block S140; setting a first difference between the first torque output and the target torque output as a maximum torque output, by the motor 130, in the first direction of motion in Block S150; and triggering the motor 130 to increase torque output toward the maximum torque output in Block S160.

The method S100 also includes: estimating a target regenerative braking output, opposite the first direction of motion, to reduce a difference between the first speed and the second speed over the change in incline angle from the first time period to the second time period in Block S130; accessing a second regenerative braking output (e.g., a current torque output, an actual torque output) by the motor 130, opposite the first direction of motion from the first time period to the second time period in Block S134; and, in response to the second regenerative braking output exceeding the target regenerative braking output, interpreting an intent at the tow vehicle to brake in Block S140, setting a second difference between the second regenerative braking output and the target regenerative braking output as a maximum regenerative braking output, by the motor 130, opposite the direction of motion in Block S150, and triggering the motor 130 to increase regenerative braking torque toward the maximum regenerative braking output in Block S160.

### 2.1 Method: Maintaining Speed Along an Incline

One variation of the method S100 includes, during a first time period: detecting a first speed of the trailer 110, a first direction of the trailer 110, and a first angle of the trailer 110 in Block S110; detecting a second speed of the trailer 110 approximating the first speed of the trailer 110 and a second incline angle of the trailer 110 in Block S110; in response to the second incline angle exceeding the first incline angle of the trailer 110, estimating a target torque output, in the first direction of motion, to maintain the first speed of the trailer 110 from the first incline angle to the second incline angle in Block S130; accessing a first torque output (e.g., a current torque output) by the motor 130 in the first direction of motion in Block S134; calculating a first difference between the first torque output and the target torque output; setting a maximum torque output by the motor 130 based on the first difference between the first torque output and the target torque output in Block S150; and triggering the motor 130 to increase torque output in the first direction of motion toward the maximum torque output in Block S160.

### 2.2 Method: Maintaining Speed Along a Decline

In another variation, the method S100 includes, during a first time period: detecting a first speed of the trailer 110, a first direction of the trailer 110, and a first angle of the trailer 110 in Block S110; detecting a second speed of the trailer 110 approximating the first speed of the trailer 110 and a first decline angle of the trailer 110 in Block S110; in response to the first decline angle falling below the first incline angle of the trailer 110, estimating a target regenerative braking torque, opposite the first direction of motion, to maintain the first speed of the trailer 110 from the first incline angle to the first decline angle in Block S130; accessing a first regenerative braking output (e.g., a current regenerative braking output), by the motor 130, opposite the first direction of motion in Block S134; detecting a first difference between the first regenerative braking output and the target regenerative braking output; setting a maximum regenerative braking output by the motor 130 based on the first difference between the first regenerative braking output and the target regenerative braking output in Block S150; and triggering the motor 130 to increase regenerative braking toward the maximum regenerative braking output in Block S160.

### 2.3 Method: Slip Ratio Limit

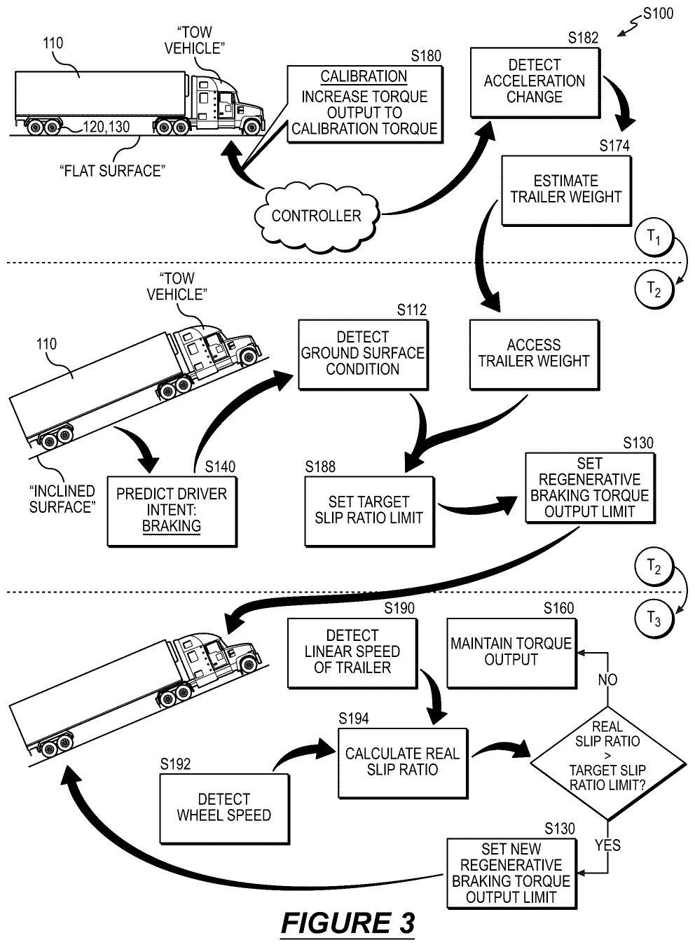

As shown in FIGS. 3, 4, and 6, one variation of the method S100 includes: detecting a speed of a trailer 110, a wheel speed of a wheel of the trailer 110, and a direction of motion of the trailer 110 during a time period in Block S110; deriving a first real slip ratio of the trailer 110 during the time period based on the speed of the trailer 110, and the wheel speed of the wheel in Block S194; and, in response to the first real slip ratio falling within a threshold range of a slip ratio limit defined for the trailer 110, deriving a target torque output, in the direction of motion, predicted to yield a second real slip ratio less than the first real slip ratio and within a target range in Block S130.

This variation of the method S100 also includes: accessing a real torque output by one or more motors 130, arranged in a bogie 160 located below a floor of the trailer 110, in the direction of motion during the time period in Block S134; calculating a difference between the target torque output and the real torque output; setting a maximum torque output by the motor 130 based on the difference between the target torque output and the real torque output in Block S150; and triggering the motor 130 to decrease torque output in the direction of motion toward the maximum torque output in Block S160.

### 2.4 Method: Torque Modulation Based on Passive Deceleration

As shown in FIGS. 1, 3, 4, 5A, and 5B, one variation of the method S100 includes, during a first time period: detecting a first deceleration of a trailer 110; and detecting a first incline angle of the trailer 110 in Block S110. This variation of the method S100 also includes: estimating a first passive deceleration component of the first deceleration based on the first incline angle in Block S120; calculating a first difference between the first passive deceleration component and the first deceleration in Block S124; and modulating torque output of a motor 130, arranged in a drive system of the trailer 110, proportional to the first difference in Block S160.

### 2.5 Method: Torque Modulation Based on Passive Acceleration

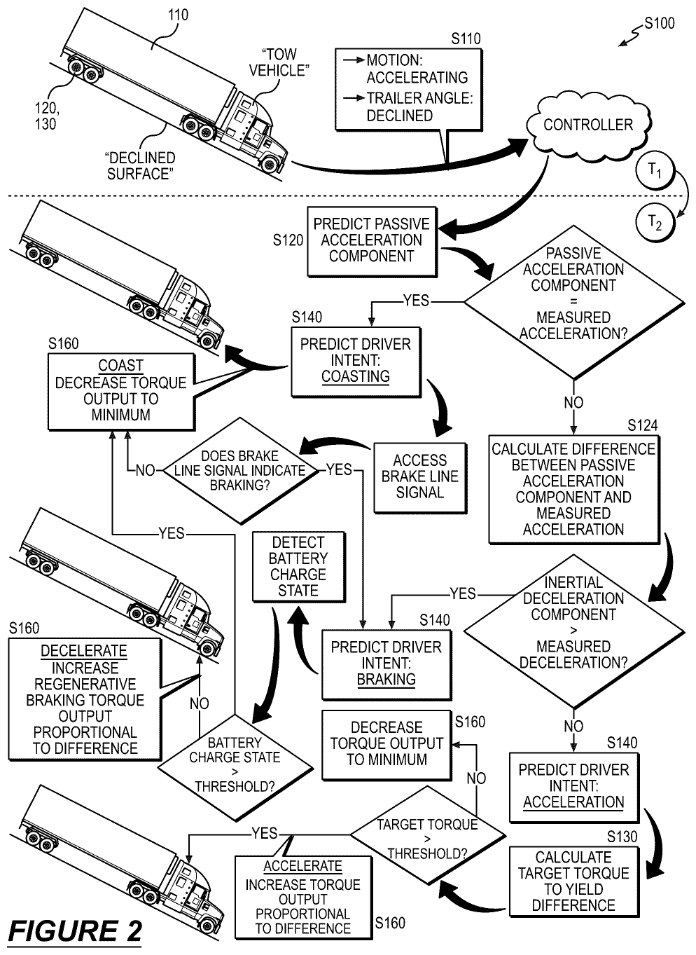

As shown in FIGS. 2 and 5B, one variation of the method S100 includes: detecting an acceleration of a trailer 110 traveling at a decline angle in Block S110; estimating a passive acceleration component of the acceleration based on the decline angle in Block S120; calculating a difference between the passive acceleration component and the acceleration in Block S124; interpreting an intent at a tow vehicle, coupled to the trailer 110, based on the difference in Block S140; and modulating torque output of a motor 130, arranged in a drive system of the trailer 110, according to the intent at the tow vehicle and proportional to the difference in Block S160.

### 3. Applications

Generally, Blocks of the method S100 can be executed by a controller within a trailer 110 towed by a tow vehicle (i.e., a “tow vehicle-trailer”) to autonomously derive navigational intent (e.g., acceleration, braking) of a driver maneuvering the tow vehicle based on accelerations, changes in ground speed, changes in trailer incline angle, changes in air pressure in brake lines, and/or changes in altitude of the trailer 110 and without direct communication with the tow vehicle and without direct measurement of forces or other interactions between the tow vehicle and the trailer 110. The controller can further execute Blocks of the method S100 to autonomously modulate torque output and regenerative braking at an electrified driven axle 120 on the trailer 110 based on this navigational intent thus derived from accelerations, changes in ground speed, changes in trailer incline angle, and/or changes in altitude of the trailer 110 over short time intervals (e.g., 100 milliseconds, one second).

In particular, the controller can detect accelerations, changes in ground (or wheel) speed (e.g., a tow vehicle-trailer combination speed), and/or changes in incline angle of the trailer 110 over a period of time (e.g., 500 milliseconds), such as based on signals read from an accelerator, a wheel speed sensor, and/or a tilt sensor arranged in the trailer 110—and not based on signals received from the tow vehicle. Based on a stored or derived weight of tow vehicle and trailer 110, the controller can then estimate a total torque output at the tow vehicle and trailer 110 necessary to achieve this change in tow vehicle-trailer combination speed over this change in incline angle over this time period. The controller can also access an actual torque output by the electrified driven axle 120 in the trailer 110 over this time period (e.g., an integral of torque output by the electrified driven axle 120 over this time period). If the estimated total torque is greater than the actual torque output, the computer system can interpret this difference in the estimated total torque and the actual torque output over this time period as supplied by the tow vehicle. Accordingly, the controller can: interpret an intent at the tow vehicle to output greater torque (e.g., to increase speed or to maintain speed up a hill); set a threshold increase in torque output by the electrified driven axle 120 equal to this difference; and then increase the torque output of the electrified driven axle 120 up to this threshold increase in torque output (e.g., 90% of this threshold increase in torque output if the trailer 110 is exhibiting no angular velocity and a battery state of charge greater than 85%; 10% of this threshold increase in torque output if the trailer 110 is exhibiting some angular velocity and/or a battery state of charge less than 25%).

Conversely, if the estimated total torque is less than this actual torque output, the controller can: interpret an intent at the tow vehicle to brake (e.g., to decrease speed or to maintain speed down a hill interpreted from signals representing engagement of the brake system of the tow vehicle from a pressure sensor); set a threshold decrease in torque output—or a threshold increase in regenerative braking—by the electrified driven axle 120 equal to this difference; and then decrease the torque output of the electrified driven axle 120 in the direction of motion of the trailer 110 up to this threshold decrease in torque output (e.g., 90% of this threshold increase in torque output if the trailer 110 is exhibiting a battery state of charge less than 40%; 10% of this threshold decrease in torque output if the trailer 110 is exhibiting a battery state of charge greater than 95%).

Therefore, the controller can autonomously derive navigational intent (e.g., acceleration, braking) of a driver maneuvering a tow vehicle based on a small quantity of sensors signals without direct communication with the tow vehicle, without direct measurement of forces or other interactions between the tow vehicle and the trailer 110, without a special digital connection to the tow vehicle, without special communications between the tow vehicle and trailer 110, without an instrumented connection between the tow vehicle and trailer 110, and without driver awareness of a connection to an electrified trailer 110. Additionally, the trailer 110 can include a small quantity of sensors—such as an accelerometer, a tilt sensor, a pressure sensor, and/or an odometer—that can be integrated into the bogie 160 and/or battery assembly 140 or arranged (e.g., outfitted) elsewhere on the trailer 110.

### 3.1 Driver Intent Derivation From Passive Motion

Additionally or alternatively, the controller can estimate an expected acceleration or deceleration component attributable to terrain-induced effects (e.g., based on gravitational force along an incline or decline) and compare this predicted component to the actual measured acceleration of the trailer 110. In particular, the controller can interpret a difference between the passive acceleration component (e.g., expected acceleration due to downhill slope) and the actual acceleration to identify a residual acceleration signal that reflects an active contribution from the tow vehicle (e.g., driver pressing the accelerator), or from an opposing system load (e.g., braking or drag). Conversely, the controller can interpret a difference between the passive deceleration component (e.g., expected deceleration due to uphill slope, rolling resistance, and/or aerodynamic drag) and the actual deceleration to identify a residual deceleration signal (e.g., suggesting driver braking).

Accordingly, the controller can infer intent at the tow vehicle based on the sign and magnitude of the difference between expected inertial acceleration and actual acceleration. For example, if the trailer 110 is descending a hill and exhibits an acceleration less than the predicted passive acceleration, the controller can infer intent at the tow vehicle to brake and trigger the electrified driven axle 120 to enter a regenerative braking mode. Conversely, if the trailer 110 is ascending a hill and decelerating at a rate that exceeds a predicted rate (i.e., predicted based on gravitational, frictional, and/or drag forces), the controller can infer intent at the tow vehicle to brake (e.g., rather than coast) and modulate torque output accordingly. Furthermore, the controller can interpret these differences as indirect indicators of kinetic energy conversion to or from gravitational potential energy and selectively control the drive system to either contribute mechanical energy (e.g., positive torque uphill) or recover kinetic energy through regenerative braking (e.g., during downhill travel).

### 3.2 Torque Modulation for Traction and Stability Control

In addition to inferring intent at the tow vehicle, the controller can modulate torque output of the electrified driven axle 120 to maintain a target slip ratio based on current surface and load conditions. For example, the controller can dynamically calculate a target slip ratio limit that maximizes traction without inducing excessive wheel slip, such as during acceleration on loose gravel or regenerative braking on wet pavement. The controller can then adjust torque output to remain within a threshold proximal this target slip ratio, thereby stabilizing trailer motion, preserving tire health, and increasing energy transfer efficiency across varying terrain types.

Furthermore, in emergency conditions such as trailer sway, lateral slip, rollover scenarios, loss of control scenarios, or jackknife scenarios, the controller can override inferred intent at the tow vehicle and autonomously apply corrective torque commands to stabilize the trailer 110. For example, the controller can detect abnormal yaw rates, lateral accelerations, or wheel flare events—based solely on onboard trailer sensors—and initiate a regenerative braking mode to increase longitudinal tension between the trailer 110 and tow vehicle. Thus, the controller can execute an emergency override to maintain directional stability and mitigate risk of rollover or loss of control, even in the absence of active commands or communication from the tow vehicle.

### 3.3 Tow Vehicle and Trailer Communications+Drivetrain Topologies

The method S100 is described herein as executed by a controller in conjunction with a suite of sensors arranged on the trailer 110 to execute Blocks of the method S100 without special communications between the tow vehicle and trailer 110. Additionally or alternatively, the method S100 can be executed by a controller in conjunction with a suite of sensors arranged within the tow vehicle to execute Blocks of the method S100 based on signals output by these sensors.

Furthermore, the method S100 is described herein as executed by a controller in conjunction with an e-axle and a single traction motor 130. However, the method S100 can be executed by a controller in conjunction with an e-axle and an open differential, a distributed drive system including independent hub motors 130, or other drivetrain topologies.

### 3.4 Intent at the Tow Vehicle

The method S100 is described herein as executed by a controller in conjunction with a suite of sensors arranged on the trailer 110 to execute Blocks of the method S100 to predict an intent of a driver of a tow vehicle (i.e., a human-operated tow vehicle), coupled to the trailer 110, to accelerate, decelerate, or maintain speed. However, the method S100 can be executed by a controller in conjunction with a suite of sensors arranged on the trailer 110 to execute Blocks of the method S100 to predict an intent of an autonomously-operated tow vehicle, coupled to the trailer 110, to accelerate, decelerate, or maintain speed.

Furthermore, the method S100 is described herein as executed by a controller in conjunction with the suite of sensors to predict intent at the tow vehicle (i.e., a human-operated tow vehicle) to accelerate, decelerate, or maintain speed without special communications between the tow vehicle and trailer 110. However, the method S100 can be executed by a controller configured to communicate with the tow vehicle to execute Blocks of the method S100 based on signals output by these sensors during periods of connectivity loss between the controller and the tow vehicle.

### 3.5 Continuous Monitoring During Motion

The method S100 is described herein as executed by a controller to detect positive (i.e., uphill) or negative (i.e., downhill) slope conditions and interpret trailer motion as acceleration or deceleration to derive torque commands accordingly. However, the method S100 can be executed by the controller to continuously modulate torque based on the signs and magnitudes of real-time sensor signals, such as acceleration and slope angle, without categorically distinguishing between states of incline, decline, acceleration, or deceleration.

Furthermore, the method S100 is described herein as implemented by a controller to execute Blocks of the method S100 based on state-based triggers (e.g., entering an incline, detecting deceleration). However, the method S100 can be executed by the controller to continuously calculate a desired torque output (or braking output) based on a continuous input stream of sensor signals reflecting real-time terrain and motion conditions.

### 4. Trailer

As shown in FIGS. 1-6, and 8A-8D, the trailer 110 includes: a set of rails; a bogie 160; a motor 130; a right wheel; a left wheel; and landing gear. In one implementation, the trailer 110 includes: a floor; a left rail coupled to the floor, extending parallel to and laterally offset from a longitudinal centerline of the trailer 110, and defining a first array of engagement features distributed along the left rail and longitudinally offset by a pitch distance; a right rail coupled to the floor, extending parallel to and laterally offset from the longitudinal centerline of the trailer 110 opposite the left rail, and defining a second array of engagement features distributed along the right rail and longitudinally offset by the pitch distance; and a bogie 160.

### 4.1 Bogie+Battery Assembly

Generally, the bogie 160 includes a chassis, a driven axle 120 suspended from the chassis, and a motor 130 coupled to the driven axle 120, similar to the bogie 160 described in U.S. application Ser. No. 18/941,813, filed on 8 Nov. 2024, and U.S. application Ser. No. 18/388,474, filed on 9 Nov. 2023, each of which is incorporated in its entirety by this reference.

In one implementation, the bogie 160 includes: a chassis configured to transiently install on a left rail and a right rail of a trailer 110 over a range of longitudinal positions (e.g., via latches configured to transiently engage engagement features of the left rail and the right rail); a driven axle 120 suspended from the chassis; and a motor 130 coupled to the driven axle 120. The drive system of the trailer can include the motor 130, the driven axle 120, and the bogie 160.

In one variation, the driven axle 120 is supported by an axle housing, suspended from the chassis, and includes a left-driven wheel and a right-driven wheel. The axle housing further encapsulates a motor 130 mounted to the driven axle 120 and is configured to protect the driven axle 120 and the motor 130 when the bogie 160 is adjusted along the floor of the trailer 110 and/or removed for service. In this variation, the motor 130 is configured to drive the left driven wheel and the right driven wheel and thus, output torque in the direction of motion of the trailer 110 in a tow mode (e.g., propulsion assist mode). The motor 130 is further configured to regeneratively brake the driven axle 120 (e.g., output torque opposite the direction of motion of the trailer 110) in a regenerative braking mode.

In another variation, the bogie 160 includes a passive axle, suspended from the chassis, adjacent the driven axle 120 and includes a left passive wheel and a right passive wheel. In this variation, the left passive wheel and the right passive wheel are configured to assist motion of the trailer 110 when the left driven wheel and the right driven wheel are driven by the motor 130 in the tow mode.

Furthermore, the system 100 can include a battery assembly 140 configured to transiently install on the trailer 110 over a range of longitudinal positions and electrically couple to the bogie 160 by a power cable (or integrated directly with the chassis of the bogie 160) in order to supply power to the motor 130. In one variation, the battery assembly 140 can include a set of modular batteries configured to engage with each other and fit within a battery frame (e.g., a stressed frame). The battery frame is configured to fit below a standard floor of a trailer 110 between the left rail and the right rail and thus, enable a user to quickly and repeatably install the battery assembly 140 or the set of modular batteries below a standard floor of any trailer 110. The set of modular batteries enables a user to selectively adjust the battery capacity of the battery assembly 140 as a function of a predicted distance traveled by the trailer 110, a weight distribution of the trailer 110, a type of the trailer 110 (e.g., a dry van trailer, a refrigerated trailer), and/or a length of the trailer 110 (e.g., 20 feet, 40 feet, 48 feet, 53 feet, 60 feet).

However, each modular battery in the battery assembly 140 can define any other shape and couple to the motor 130 in any other way.

### 4.2 Sensors

The system 100 can include: a set of sensors—such as inertial sensors (e.g., an IMU, an accelerometer, a gyroscope), pressure sensors, tilt sensors (e.g., an inclinometer), and/or optical sensors (e.g., a one-dimensional depth sensor, a LIDAR sensor, an RGB camera)—arranged on the trailer 110 and configured to output signals representing conditions of the trailer 110 to the controller.

In one variation, the system 100 can include a set of pressure sensors configured to output signals corresponding to air pressure in brake lines of the trailer 110. Each pressure sensor can then transmit these signals to the controller. In one example, the system 100 includes a pressure sensor configured to output signals corresponding to air pressure of an emergency brake line (e.g., a supply brake line) system of the trailer 110 from an air supply of the tow vehicle and transmit these signals to the controller. In another example, the system 100 includes a pressure sensor coupled to the driven axle 120 and configured to output signals corresponding to air pressure of air bags in an air-ride suspension system coupled to the driven axle 120 and transmit these signals to the controller. In yet another example, the system 100 includes a pressure sensor configured to couple to a signal brake line and output signals corresponding to air pressures at the signal brake line, extending from the tow vehicle to the trailer 110, from an air supply of the tow vehicle and transmit these signals to the controller.

In another variation, the system 100 can include a set of wheel speed sensors configured to output signals representing inertial conditions of the trailer 110—such as speed, direction of motion, or acceleration of the trailer 110—relative to a ground surface below the trailer 110. Each wheel speed sensor is coupled to a corresponding driven wheel of the trailer 110 and/or a passive wheel of the trailer 110 and transmits these signals to the controller.

In yet another variation, the system 100 can include a set of optical sensors arranged on a proximal end of the trailer 110 and facing a tow vehicle coupled to the trailer 110. Each optical sensor is configured to output signals (e.g., capture images) representing brake conditions (e.g., engaged or disengaged) of the tow vehicle coupled to the trailer 110 and transmit these signals to the controller.

### 4.3 Kingpin

The system 100 further includes a kingpin: arranged on a proximal end of the trailer 110 opposite the bogie 160; configured to interface with a hitch (e.g., a fifth wheel) of a tow vehicle (e.g., a tow vehicle trailer, a semitruck, a semi); and characterized by a unitary steel alloy structure. The kingpin includes: a head; a shank; a base; and a set of fasteners.

In one implementation, the kingpin is coupled to a floor of the trailer 110 and is configured to transfer vertical loads from the trailer 110 into a hitch of a tow vehicle. The kingpin includes: a head defining a first diameter; a shank defining a second diameter less than the first diameter; and the base defining a third diameter greater than the first diameter of the head and the second diameter of the shank. The base further defines a set of through-bores arranged radially about the shank and configured to receive a set of fasteners to couple the kingpin to a floor of the trailer 110 and thus, fasten the kingpin to the trailer 110. Further, the shank is configured to transiently couple to the hitch of the tow vehicle.

### 4.4 Controller

The controller is coupled to sensors within the system 100 and executes the methods and techniques described below: to access signals output by sensors coupled to a proximal end, a brake line, a suspension system, and wheels of the trailer 110; to detect a baseline state (e.g., a steady-state) of the trailer 110—such as a speed, a direction of motion, a weight, and/or an incline angle of the trailer 110—based on these signals at an initial time; to detect an angle rate of change of the trailer 110 between the initial time and a first time; and to estimate a target torque output and/or a target regenerative braking output to maintain the baseline state as a function of the angle rate of change between the initial time and the first time.

The controller can further: interpret an intent of a driver associated with a tow vehicle coupled to the trailer 110; select a mode (e.g., tow mode, coasting mode, or regenerative braking mode) for the motor 130 based on the intent at the tow vehicle; and modulate torque output of the motor 130 according to the mode. In one variation, the controller can: interpret an intent at the tow vehicle and/or set a maximum torque output by the motor 130 of the bogie 160, based on the difference between the current torque output and the target torque output; detect a charge state (e.g., a status, a level, a percentage) of the battery assembly 140; and selectively adjust the torque output, by the motor 130, proportional to the charge state of the battery assembly 140 and toward the maximum torque output.

In one variation, the controller can: interpret an intent at a tow vehicle coupled to the trailer 110 and/or set a maximum regenerative braking output by the motor 130 of the bogie 160, based on a difference between a current regenerative braking output and the target regenerative braking output; detect a charge state of the battery assembly 140; and selectively adjust a regenerative braking output, by the motor 130, inversely proportional to the charge state of the battery assembly 140 and toward the maximum regenerative braking output.

### 5. Modular Retrofit Drive Kit for Existing Trailers

In one implementation, the system 100 can include a kit of components configured to install (i.e., retrofit) on an existing trailer platform. In particular, rather than including a bogie 160 that includes the frame, suspension, and axle assembly of the trailer 110, the system 100 can include a set of modular components configured to integrate with a wide range of conventional trailers. In this implementation, the system 100 includes: a driven axle 120; a motor 130; a battery assembly 140; and a controller. The driven axle 120 is configured to mount to a trailer 110 (e.g., via standard axle brackets or hanger mounts). In one variation, the driven axle 120 is configured to replace an existing passive axle on the trailer 110 without requiring modification to the braking or load-bearing structure of the trailer 110.

The motor 130 is: coupled to the driven axle 120; configured to output torque to the driven axle 120; and configured to regeneratively brake the driven axle 120. The battery assembly 140 is arranged on the trailer 110 and electrically coupled to the motor 130. In particular, the battery assembly 140 is configured to: install on the trailer 110; supply electrical energy to the motor 130 to drive the driven axle 120 (i.e., when the motor 130 is in tow mode); and receive electrical energy from the motor 130 to recharge the battery assembly 140 (i.e., when the motor 130 is in regenerative braking mode).

The controller is configured to: detect a deceleration (or an acceleration) of the trailer 110; detect an incline angle (or a decline angle) of the trailer 110; estimate a passive deceleration component (or a passive acceleration component) of the deceleration (or acceleration) based on the incline angle (or the decline angle); calculate a difference between the passive deceleration component and the deceleration (or a difference between the passive acceleration component and the acceleration); and modulate torque output of the motor 130 (i.e., to apply torque or regenerative braking) proportional to the difference. Therefore, the controller can trigger a motor 130 coupled to an individual driven axle 120 to output torque to the driven axle 120 or regeneratively brake the driven axle 120, and thus, manipulate the driven wheels of the trailer 110 in a tow mode and in a regenerative braking mode.

### 6. Tow Mode

Generally, the user (e.g., an operator, a driver, a yard manager) or a machine (e.g., a forklift) couples the hitch (e.g., a fifth wheel) of a tow vehicle to the kingpin. The controller can: interpret a coupling event between the kingpin and the hitch of the tow vehicle (e.g., via a signal from an IMU sensor arranged on the proximal end of the trailer 110 facing the tow vehicle coupled to the trailer 110); and, in response to interpreting the coupling event between the kingpin and the hitch of the tow vehicle, enter a tow mode (e.g., a propulsion assist mode).

In one implementation, in tow mode, the controller can detect conditions of the trailer 110 during a time interval (e.g., three seconds, thirty seconds, one minute), such as: a weight of the trailer 110 on the driven axle 120; a direction of motion of the trailer 110; a speed of the trailer 110; and an incline angle of the trailer 110 (e.g., a grade or slope of a ground surface below the trailer 110). The controller can then: define a baseline state for the trailer 110 during this time interval; detect conditions of the trailer 110 during a next time interval; estimate a target torque output in the direction of motion as a function of changes in conditions of the trailer 110 between time intervals; detect a current torque output by the trailer 110 at the baseline speed; calculate a difference between the target torque output and the current torque output; and selectively trigger the motor 130 of the bogie 160 to increase or decrease torque output according to the difference between the target torque output and the current torque output.

More specifically, the controller can: define a baseline state for the trailer 110, such as a first speed (e.g., a constant speed), a first baseline direction of motion, a first weight, and a first incline angle, during a time interval; detect conditions of the trailer 110 during a next time interval, such as a second direction of motion, a second speed, and a second incline angle of the trailer 110; detect a rate of change of the incline angle between time intervals; estimate a target torque output, in the first direction of motion, to maintain the first speed as a function of the rate of change of the incline angle; detect a current torque output by the motor 130 of the bogie 160, arranged below the floor of the trailer 110, at the first speed; and calculate a difference between the current torque output and the predicted target torque output. The controller can: set a maximum torque output for the motor 130 based on the difference; and trigger the motor 130 to increase or decrease torque output, in the first direction of motion, according to the maximum torque output.

Additionally, the controller can: detect conditions of the trailer 110, such as a direction of motion, a speed, and a decline angle of the trailer 110, during a next time interval; detect a rate of change of the incline angle between time intervals; estimate a target regenerative braking output, in the direction of motion, to maintain the baseline speed as a function of the rate of change of the incline angle; detect a current regenerative braking output by the motor 130 of the bogie 160, arranged below the floor of the trailer 110, at the baseline speed; and calculate a difference between the current regenerative braking output and the predicted target regenerative braking output. The controller can: set a maximum regenerative braking output, by the motor 130 of the bogie 160, based on the difference between the current regenerative braking output and the predicted target regenerative braking output; and trigger the motor 130 to increase or decrease regenerative braking, opposite the baseline direction of motion, to achieve the baseline state of the trailer 110.

### 7. Baseline State: Weight of Trailer

In one variation, the controller can: detect conditions of the trailer 110, such as a weight of the trailer 110 on the driven axle 120 and/or the passive axle, a direction of motion of the trailer 110, a speed of the trailer 110, and an incline angle of the trailer 110 (e.g., a grade or slope of a ground surface below the trailer 110); and track these conditions during a time interval (e.g., three seconds, thirty seconds, one minute, five minutes) in order to define a baseline state for the trailer 110.

Furthermore, prior to entering tow mode, the controller can: access a weight of a tow vehicle coupled to the trailer 110; detect a weight of the trailer 110, containing a load, on the driven axle 120 via pressure sensors coupled to the air-ride suspension system; access a weight database from a remote computer system; and/or interface with a remote computer system to retrieve an estimated weight of the trailer 110 defined by a user prior to the tow mode. The controller can then represent the weight of the trailer 110 as a baseline weight.

Additionally or alternatively, the user can estimate a load contained in the trailer 110 and interface with the user portal to select a weight status indicator—such as a numerical metric (e.g., 0% weight=empty, 50% weight=half-load, 100%=maximum load)—for the trailer 110 associated with the estimated load. Once in tow mode, the controller can then: access the weight status indicator defined by the user; interpret a weight of the trailer 110, containing a load, on the driven axle 120; identify this load as a baseline load for the trailer 110; and detect initial conditions of the trailer 110 (e.g., a speed, a direction of motion, an incline angle) during a time interval to define a baseline state for the trailer 110.

In yet another variation, a user (e.g., an operator, a driver, a manager) may estimate an initial load, contained in the trailer 110, prior to the tow mode and interface with a user portal to define the load for the trailer 110. The controller can then: access a signal from the pressure sensor; based on the signal, approximate a load of the trailer 110 on the driven axle 120 to verify the initial load estimated by the user; and store this load as a baseline weight for the trailer 110 in tow mode. Once in tow mode, the controller can: retrieve the load for the trailer 110; identify this load as a baseline load for the trailer 110; and detect initial conditions of the trailer 110 (e.g., a speed, a direction of motion, an incline angle) during a time interval to define a baseline state for the trailer 110.

In another variation, a user (e.g., an operator, a driver, a manager) may estimate a load, contained in the trailer 110, prior to the tow mode and interface with a user portal to define the load for the trailer 110. Once in tow mode, the controller can: retrieve the load for the trailer 110; identify this load as a baseline load for the trailer 110; and detect initial conditions of the trailer 110 (e.g., a speed, a direction of motion, an incline angle) during a time interval to define a baseline state for the trailer 110.

However, the controller can detect conditions of the trailer 110 and define a baseline state for the trailer 110 in any other way.

### 7.1 Trailer Weight Estimation Based on Air Suspension Signals

In one variation, Blocks of the method S100 recite: accessing a signal from a pressure sensor coupled to the drive system in Block S170; detecting an air pressure within a pneumatic suspension system supporting the drive system based on the signal in Block S172; and estimating a weight of the trailer 110 based on the air pressure, an area coefficient representing an effective surface area of the pneumatic suspension system, and a weight distribution scalar representing a proportion of weight of the trailer 110 supported by the pneumatic suspension system in Block S174.

In one variation, the bogie 160 can include an air-ride suspension system coupled to the driven axle 120 and a pressure sensor configured to output signals representing combined air pressures of air bags in the air-ride suspension system. The controller can: access a signal from the pressure sensor; approximate a weight of the trailer 110 (e.g., a load, a payload) on the driven axle 120 based on the signal; and store this weight as a baseline weight for the trailer 110 in tow mode. In tow mode, the controller can detect initial conditions of the trailer 110 (e.g., a speed, a direction of motion, an incline angle) during a time interval and represent the baseline weight and these initial conditions as a baseline state for the trailer 110 for a next time interval.

In another variation, the controller can: access a signal from the pressure sensor; detect an air pressure within the pneumatic suspension system supporting the drive system based on the signal; and estimate a weight of the trailer 110. In particular, the controller can estimate the weight of the trailer 110 based on a function relating: the air pressure; an area coefficient representing an effective surface area of the pneumatic suspension system; and a weight distribution scalar representing a proportion of weight of the trailer 110 supported by the pneumatic suspension system.

More specifically, the area coefficient can represent an effective surface area over which air pressure acts in the pneumatic suspension system (e.g., derived from the geometry and membrane dimensions of the suspension airbags). Additionally, the weight distribution scalar can represent a ratio between the load borne by the pneumatic suspension system and the total trailer weight (e.g., accounting for additional axles or load transfer to the tow vehicle). Based on the detected air pressure, the area coefficient, and the weight distribution scalar, the controller can estimate a vertical load supported by the suspension system and extrapolate a total trailer weight. Thus, in this variation, the controller can infer an approximate real-time trailer weight during operation by analyzing pneumatic pressure conditions and leverage this estimated weight to improve accuracy in torque control, traction management, and regenerative braking predictions across different trailer configurations and load conditions.

### 7.2 Trailer Weight Estimation via Active Torque Calibration

In one variation, Blocks of the method S100 recite, during a calibration period: triggering the motor 130 to output a calibration torque while the trailer 110 travels at a constant speed on flat ground in Block S180; detecting an acceleration responsive to output of the calibration torque by the drive system of the trailer in Block S182; and estimating a weight of the tow vehicle and the trailer 110 based on the calibration torque, and the acceleration in Block S174.

In this variation, the controller can perturb the trailer 110 by applying a known torque to generate a controlled acceleration response to estimate a weight of the tow vehicle and the trailer 110. In particular, the controller can trigger the motor 130 to output a known input torque and observe a resulting change in trailer acceleration under stable conditions (e.g., constant speed and flat terrain). By perturbing the trailer 110 during periods of low dynamic variability, the controller can accurately estimate a weight of the tow vehicle and the trailer 110 that reflects actual load conditions on the trailer 110, without relying on signals from additional load sensors or suspension systems.

In this variation, the controller can: trigger the motor 130 to output a calibration torque while the trailer 110 travels at a constant speed on flat ground; and detect an acceleration responsive to output of the calibration torque. The controller can then estimate the weight of the tow vehicle and the trailer 110 based on: the calibration torque; and the acceleration. More specifically, the controller can: interpret the acceleration as a longitudinal force applied to the trailer 110; calculate the effective tractive force generated by the calibration torque at the driven axle 120 (e.g., by dividing torque by wheel radius); and calculate the trailer weight as a function of the ratio between the tractive force and the measured acceleration. Thus, in this variation, the controller can estimate the real-time weight of the tow vehicle and the trailer 110—without relying on external pressure-based inputs—by executing an active torque pulse and interpreting the resulting acceleration as a function of applied force.

In another variation, the controller can estimate the weight of the trailer 110 based on a gear shift event at the motor 130. In particular, the controller can detect a transition between two adjacent gear states of the motor, infer a difference in torque output of the motor between the gear states. By inferring the difference in torque and the resulting change in acceleration, the controller can estimate the weight of the trailer 110. For example, if the trailer shifts to a higher gear and the motor torque output drops by a known amount, the controller can interpret the corresponding reduction in acceleration as indicative of trailer mass. Therefore, the controller can derive real-time weight estimates based on gear-induced force changes and corresponding trailer response.

### 8. Baseline State: Initial Conditions of Trailer

In one variation, the controller can: detect initial conditions of the trailer 110 during a time interval (e.g., thirty seconds, one minute, five minutes); and store averages of these initial conditions as a baseline state for the trailer 110 as the trailer 110 traverses a flat, ground surface.

In one variation, during a time period (e.g., one minute) the controller can: detect a speed and a direction of motion of the trailer 110; and detect an angle of the trailer 110 relative to a ground surface below the trailer 110. The controller can then: derive an average speed of the trailer 110 during this time period; derive an average angle of the trailer 110 during this time period; and represent the weight, the average speed, the direction of motion, and the average angle as a baseline state of the trailer 110. The controller can further access a torque output by the motor 130 of the bogie 160 during this time period and associate this torque output with the baseline state for the trailer 110.

For example, during a time period (e.g., one minute), the controller can: access a first signal, representing speeds of the trailer 110, from an IMU sensor arranged on the proximal end of the trailer 110 facing a tow vehicle coupled to the trailer 110; detect a constant speed, such as 50 miles-per-hour, and a forward direction of motion of the trailer 110 based on the first signal; access a second signal, representing angles of the trailer 110 relative to the ground surface, from a tilt sensor arranged on the proximal end of the trailer 110; detect an average angle of the trailer 110, such as 1.15 degrees relative to the ground surface below the trailer 110 or a 2% slope of the ground surface, based on the second signal; and represent the constant speed, the initial direction, the average angle, and the weight of the trailer 110 as a baseline state for the trailer 110.

The controller can then: calculate an acceleration rate of the trailer 110 during this time period based on signals output from the accelerometer or IMU sensor; and transform the acceleration rate of the trailer 110 during this time period and the weight of the trailer 110 into a torque output by the motor 130 of the bogie 160 (e.g., an acceleration torque); and associate this torque output with the baseline state for the trailer 110.

Additionally or alternatively, the controller can: access signals from a set of wheel speed sensors—each wheel speed sensor coupled to a corresponding driven wheel of the driven axle 120 of the trailer 110—representing speeds of the trailer 110 relative to the ground surface; and implement methods and techniques described above to define the baseline state for the trailer 110. The controller can further: calculate an acceleration rate of the trailer 110 during a particular time period based on signals output from the set of wheel speed sensors; and transform the acceleration rate of the trailer 110 during this particular time period and the weight of the trailer 110 into a torque output by the motor 130 of the bogie 160 (e.g., an acceleration torque) and associate this torque output with the baseline state for the trailer 110.

Therefore, the controller can cooperate with sensors in the system 100 to detect initial conditions of the trailer 110 navigating along a flat, ground surface in order to define a baseline state (e.g., a steady-state, a constant speed) for the trailer 110 for future time periods.

### 9. Positive Sloped Surface: Estimate Target Torque Output

In one variation, Blocks of the method S100 recite: estimating a target torque output, in a first direction of motion, to reduce a difference between a first speed and a second speed over a change in incline angle from a first time period to a second time period in Block S130; accessing a first torque output (e.g., a current torque output, an actual torque output) by a motor 130, arranged in a bogie 160 located below a floor of the trailer 110, in the first direction of motion from the first time period to the second time period in Block S134; in response the first torque output exceeding the target torque output: setting a first difference between the first torque output and the target torque output as a maximum torque output, by the motor 130, in the first direction of motion in Block S150; and triggering the motor 130 to increase torque output toward the maximum torque output in Block S160.

In this variation, as shown in FIGS. 5A and 5B, upon completion of the time interval, the controller can: track conditions of the trailer 110 over a next time interval; detect an angle of the trailer 110, greater than the baseline angle of the trailer 110, relative to the ground surface; and estimate a target torque output, as a function of the change in angle of the trailer 110, to maintain a constant speed of the trailer 110, detected during the previous time interval.

In one variation, the controller can: detect a speed of the trailer 110 corresponding to (e.g., matching, approximating) the baseline speed of the trailer 110; detect an incline angle and direction of motion of the trailer 110 representing motion of the trailer 110 along a positive sloped surface (e.g., uphill); detect a difference between the baseline angle and the current incline angle of the trailer 110; and estimate a torque output to maintain the constant speed of the trailer 110 as a function of the difference between the angle, detected during the previous time interval, and the current incline angle of the trailer 110.

For example, the controller can: detect a speed of the trailer 110 approximating the previous speed of the trailer 110, such as 50 miles-per-hour, and a forward direction of motion of the trailer 110 via an accelerometer or an IMU sensor; detect a current incline angle, such as 5 degrees relative to a ground surface, via a tilt sensor arranged on the proximal end of the trailer 110; detect forward motion of the trailer 110 traverses a positive sloped surface; and detect a difference, such as 4.85 degrees, between the angle, detected during the previous time interval, and the current incline angle of the trailer 110. The controller can then transform the speed of the trailer 110 over the time period, acceleration of the tow vehicle-trailer 110 due to gravity, the weight of the tow vehicle, and the baseline weight of the trailer 110 into a target torque output to maintain the constant speed of the trailer 110 as the trailer 110 moves along the positive sloped surface. Therefore, the controller can estimate (e.g., request) a target torque output, for the motor 130 of the bogie 160, to maintain a constant speed of the trailer 110 while the trailer 110 moves along a positive sloped surface in order to assist forward motion of the tow vehicle.

### 10. Positive Sloped Surface: Maximum Torque Output+Intent at Tow Vehicle

Furthermore, the controller can: detect a current torque output by the motor 130; calculate a difference between the current torque output and the requested torque output; and set a maximum torque output, by the motor 130, based on the difference between the current torque output and the requested torque output while the trailer 110 moves along this positive sloped surface.

In one implementation, the controller can: detect a current torque output reported by the motor 130; calculate a difference between the current torque output and the predicted torque output; and, in response to the difference exceeding a torque output difference threshold, set a maximum torque output, by the motor 130, based on the difference between the current torque output and the requested torque output while the trailer 110 traverses this positive sloped surface.

In one variation, the controller can: detect a current torque output by the motor 130 via a torque sensor; calculate a difference between the current torque output and the requested torque output; and interpret the difference between the current torque output and the requested torque output as an intent at a tow vehicle coupled to the trailer 110, to accelerate the tow vehicle.

For example, the controller can: detect a current torque output, such as 900 pounds-feet, reported by the motor 130; calculate a positive difference, such as +20 pounds-feet, between the current torque output and the requested torque output (e.g., between 900 pounds-feet and 920 pounds-feet); identify the positive difference as an intent at a tow vehicle coupled to the trailer 110, to engage the gas pedal of the tow vehicle to accelerate the tow vehicle in the forward motion and to increase the speed of the trailer 110 above the baseline speed; and represent the positive difference as the maximum torque output, in the forward direction of motion, for the motor 130 during this time interval.

Thus, the controller can: detect a difference between a current torque output by the motor 130 of the trailer 110 and a requested target torque output for the motor 130; automatically identify the difference as a maximum torque output for the motor 130; and interpret an intent at the tow vehicle from this difference in order to trigger the motor 130 to selectively increase or reduce the torque output to the driven axle 120 of the trailer 110, as further described below.

### 11. Negative Sloped Surface: Estimate Target Regenerative Braking

In one variation, as shown in FIGS. 5A and 5B, the controller can implement methods and techniques described above: to track conditions of the trailer 110 over a next time interval; to detect an angle of the trailer 110, less than the baseline angle of the trailer 110, relative to the ground surface; to identify the angle of the trailer 110 as a decline angle; to trigger regenerative braking by the motor 130; and to estimate (e.g., request) a target regenerative braking output, as a function of the change in angle of the trailer 110, to maintain a constant speed of the trailer 110 between the previous time interval and the current time interval.

In one implementation, the controller can: detect a speed of the trailer 110 approximating the speed of the trailer 110, detected during the previous time interval; detect a decline angle and direction of motion of the trailer 110 representing motion of the trailer 110 along a negative sloped surface (e.g., downhill); detect a difference between the angle, detected during the previous time interval, and the current decline angle of the trailer 110; and request a target regenerative braking output, opposite the direction of motion, to maintain a constant speed of the trailer 110.

For example, the controller can: detect a speed of the trailer 110 approximating the speed of the trailer 110, detected during the previous time interval, such as 50 miles-per-hour, and a forward direction of motion of the trailer 110 via an accelerometer or an IMU sensor; detect a current decline angle, such as −3 degrees relative to a ground surface, via a tilt sensor arranged on the proximal end of the trailer 110; identify forward motion of the trailer 110 moving along a negative sloped surface; and detect a difference, such as 4.15 degrees, between the angle, detected during the previous time interval, and the current decline angle of the trailer 110. The controller can then transform the speed of the trailer 110 over the time period, acceleration of the tow vehicle-trailer 110 due to gravity, the weight of the tow vehicle, and the baseline weight of the trailer 110 into a target regenerative braking output, for the motor 130, to maintain the constant speed of the trailer 110 as the trailer 110 moves along the negative sloped surface.

### 12. Negative Sloped Surface: Maximum Regenerative Braking+Driver Intent

Furthermore, the controller can: detect a current regenerative braking output by the motor 130; calculate a difference between the current regenerative braking output and the requested target regenerative braking output; and identify the difference as the maximum regenerative braking output for the motor 130 while the trailer 110 traverses this negative sloped surface.

In one implementation, the controller can: detect a current regenerative braking torque reported by the motor 130; calculate a difference between the current regenerative braking output and the requested target regenerative braking output; and, in response to the difference exceeding a torque output difference threshold, identify the difference between the current torque output and the requested torque output as the maximum regenerative braking output, for the motor 130, while the trailer 110 traverses this negative sloped surface. The controller can further: interpret the difference between the current regenerative braking output and the requested target regenerative braking output as an intent at a tow vehicle coupled to the trailer 110, to decelerate the tow vehicle.

For example, the controller can: detect a negative difference, such as −25 pounds-feet, between the current regenerative braking output and the requested target regenerative braking output; identify the negative difference as an intent at the tow vehicle to engage the brake pedal of the tow vehicle to decrease the speed of the trailer 110 below the baseline speed; access a signal representing engagement of the brake system of the tow vehicle from a pressure sensor, such as coupled to a gladhand of a brake line from the tow vehicle or coupled to the signal brake line; confirm the intent at the tow vehicle to decrease the speed of the trailer 110 based on the signal; and represent the negative difference as the maximum regenerative braking output, in the opposite direction of motion, for the motor 130 during this time interval.

Thus, the controller can: detect a difference between a current regenerative braking output by the motor 130 of the trailer 110 and a target regenerative braking output; automatically identify the difference as a maximum regenerative braking output for the motor 130; and, from this difference, interpret an intent at the tow vehicle in order to trigger the motor 130 to selectively increase or reduce the regenerative braking output to the driven axle 120 of the trailer 110.

### 13. Inertial Acceleration and Deceleration Components+Torque Output Modulation

In one implementation, the controller can: detect a deceleration (or an acceleration) of the trailer 110; interpret a component of the deceleration (or acceleration) as passive (i.e., attributable to gravitational, frictional, rolling, and/or drag forces acting along an incline or decline); and modulate torque output of the motor 130 proportional to the remaining, active (i.e., driver-induced or propulsion-induced) component of acceleration. More specifically, during a particular time period, the controller can: access a first signal, representing linear acceleration of the trailer 110, from an accelerometer arranged on the trailer 110; detect a deceleration (or an acceleration) of the trailer 110 based on the first signal; access a second signal, representing angles of the trailer 110 relative to the ground surface, from a tilt sensor arranged on the trailer 110; and detect an incline angle (or a decline angle) of the trailer 110.

The controller can then estimate a passive deceleration component (or a passive acceleration component) of the deceleration (or acceleration) based on the incline angle (or the decline angle). In particular, the controller can estimate the passive deceleration component (or the passive acceleration component) based on a function relating: the incline angle (or decline angle); gravitational acceleration; rolling resistance, aerodynamic drag, and surface friction forces acting on the trailer 110; and an estimated or predefined mass of the trailer 110.

The controller can then: calculate a difference between the passive deceleration component and the measured deceleration (or a difference between the passive acceleration component and the measured acceleration); and modulate torque output of the motor 130 proportional to the difference. For example, the controller can modulate torque output of the motor 130 proportional to the difference, such as linearly proportional to or non-linearly proportional to the difference. More specifically, based on the detected angle, the controller can estimate the portion of acceleration or deceleration attributable to gravitational forces, rolling resistance, aerodynamic drag, and/or surface friction acting on the trailer 110 along the slope. The controller can then subtract this passive component from the overall measured acceleration (or deceleration) to calculate a portion of acceleration (or deceleration) attributable to active driving forces (e.g., propulsion or braking commands from the driver of the tow vehicle). The controller can then modulate torque output of the motor 130 based on the magnitude and direction of the remaining, active component. For example, the controller can: detect a deceleration of the trailer 110 on a downhill slope; calculate a passive component that accounts for a relatively large proportion of the measured deceleration; and reduce regenerative braking to avoid unnecessary energy recovery or over-braking. Conversely, the controller can: detect an acceleration of the trailer 110 on an uphill slope; calculate a passive component that is insufficient to maintain the desired motion; and increase torque output to compensate for the gravitational resistance.

In one implementation, the controller can: set a maximum torque output by the motor 130 based on the difference (e.g., the difference between the acceleration and the passive acceleration component); and trigger the motor 130 to increase or decrease torque output, in the direction of motion of the trailer 110, toward the maximum torque output. Alternatively, the controller can: set a maximum regenerative braking output by the motor 130 based on the difference (e.g., the difference between the deceleration and the passive deceleration component); and trigger the motor 130 to increase or decrease regenerative braking, opposite the direction of motion of the trailer 110, toward the maximum regenerative braking output. Therefore, the controller can implement torque control or regenerative braking control by: implementing a minimal set of sensors (e.g., a single accelerometer and tilt sensor) configured to detect active versus passive contributions to trailer motion; and triggering torque commands accordingly.

### 14. Positive Sloped Surface: Interpretation of Inertial Deceleration

Blocks of the method S100 recite: detecting a deceleration of a trailer 110 during a time period; detecting an incline angle of the trailer 110 during the time period in Block S110; estimating a passive deceleration component of the deceleration based on the incline angle in Block S120; calculating a difference between the passive deceleration component and the deceleration in Block S124; and modulating torque output of a motor 130, arranged in a drive system of the trailer 110, proportional to the difference in Block S160.

In one implementation, as shown in FIG. 1, the controller can execute Blocks of the method S100 to: detect an incline angle and direction of motion of the trailer 110 representing motion of the trailer 110 along a positive sloped surface (e.g., uphill); detect a deceleration of the trailer 110 representing a decrease in velocity during uphill travel; and interpret a residual deceleration component indicating active braking or increased rolling resistance. More specifically, the passive deceleration component can be attributed to one or more contributing forces acting opposite the direction of motion, including: gravitational resistance from uphill slope; rolling resistance between tires and surface; mechanical drag from drivetrain components; and/or or aerodynamic drag. For uphill motion, the passive deceleration component can represent a conversion of kinetic energy into potential energy, wherein a portion of the forward momentum of the trailer 110 is expended to increase elevation.

In this implementation, during a particular time period, the controller can: detect a deceleration of the trailer 110 (e.g., via an accelerometer); and detect an incline angle of the trailer 110 (e.g., via a tilt sensor). The controller can then: estimate a passive deceleration component of motion of the trailer 110 (e.g., based on gravitational force acting along the incline); and calculate a difference between the passive deceleration component and the actual deceleration detected by the accelerometer. More specifically, the controller can calculate a difference representing a residual component of deceleration that suggests the driver of the tow vehicle is actively braking. Based on this difference, the controller can selectively modulate torque output of the motor 130. Therefore, the controller can: interpret a residual deceleration component, unaccounted for by the passive deceleration, as indicative of external braking input or increased resistance acting on the trailer 110; and selectively adjust torque output of the motor 130 to either counteract the resistance and assist in uphill motion or maintain deceleration (i.e., when the driver intends to brake).

### 15. Positive Sloped Surface: Driver Intent

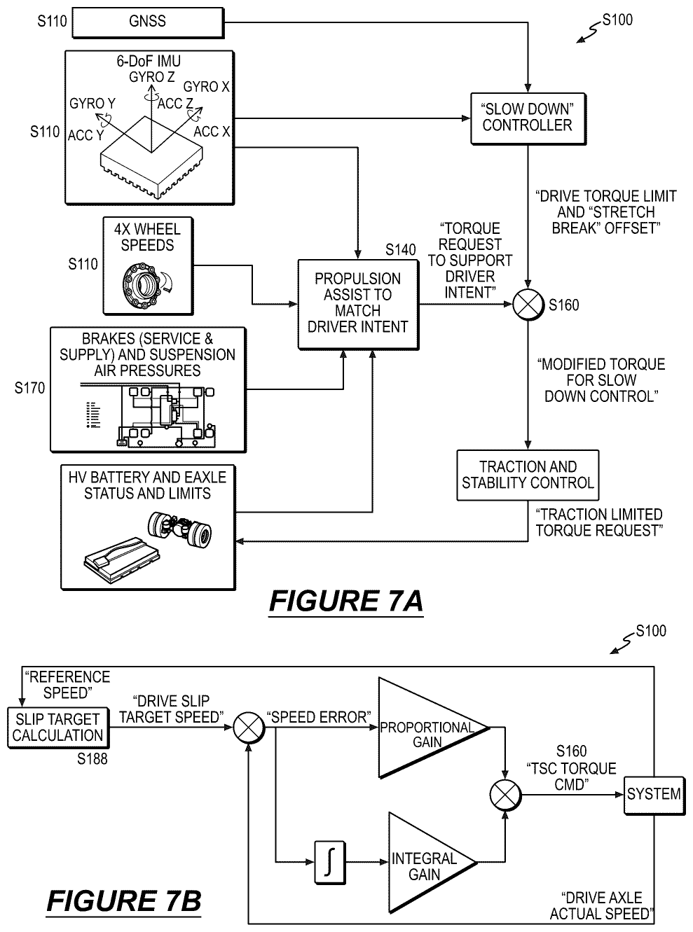

In one implementation, the controller can infer an intent at the tow vehicle based on a difference between a passive deceleration component—predicted based on incline angle—and an actual deceleration of the trailer 110. In particular, the controller can: implement methods and techniques described above to calculate a difference between a passive deceleration component and a measured deceleration; interpret the difference to infer a corresponding intent at the tow vehicle; and selectively adjust torque output of the motor 130 based on the intent at the tow vehicle, as shown in FIGS. 1, 7A, and 7B.

In one variation, in response to the passive deceleration component exceeding the deceleration, the controller can interpret an intent at the tow vehicle to accelerate. The controller can then increase torque output of the motor 130, proportional to the difference between the passive deceleration component and the deceleration, to assist in forward motion. In particular, the controller can: calculate a longitudinal force predicted to yield the observed difference based on the estimated weight of the tow vehicle and the trailer 110; calculate a target torque output of the motor 130 based on the longitudinal force and a wheel radius of the trailer 110; and modulate torque output of the motor 130 according to the target torque output.

For example, the controller can: detect a 10° incline angle; detect a deceleration of 2.5 m/s²; estimate a passive deceleration component of 1.7 m/s²; and calculate a difference of 0.8 m/s² between the passive deceleration component and the measured deceleration. The controller can then trigger the motor 130 to: apply positive torque to the driven axle 120 to counteract the residual deceleration and assist in maintaining uphill motion (e.g., when the driver intends to maintain speed); or maintain or increase regenerative braking torque to reinforce the deceleration (e.g., when the driver intends to brake).

In another variation, in response to the deceleration approximating the passive deceleration component, the controller can: interpret an intent at the tow vehicle to coast; and disable torque output assist, such that the trailer 110 rolls passively down the slope without active propulsion or braking. In particular, the controller can decrease torque output of the motor 130 toward null torque output and null braking torque output.

In yet another variation, in response to the deceleration exceeding the passive deceleration component, the controller can interpret an intent at the tow vehicle to decelerate (i.e., brake). In particular, the controller can increase regenerative braking of the motor 130 proportional to the difference between the passive deceleration component and the deceleration. Therefore, the controller can: detect a difference between the passive deceleration component and the actual deceleration of the trailer 110; automatically identify whether the trailer 110 is actively accelerating, coasting, or decelerating beyond gravitational contribution; interpret the intent at the tow vehicle from this difference; and selectively increase or reduce torque output (or regenerative braking output) of the motor 130 to support the inferred intent during uphill travel.

### 16. Negative Sloped Surface: Interpretation of Inertial Acceleration

Blocks of the method S100 recite: detecting an acceleration of the trailer 110; detecting a decline angle of the trailer 110 in Block S110; estimating a passive acceleration component of the acceleration based on the decline angle in Block S120; calculating a difference between the passive acceleration component and the acceleration in Block S124; and modulating torque output of the motor 130 proportional to the difference in Block S160.

In one implementation, as shown in FIG. 2, the controller can execute Blocks of the method S100 to: detect a decline angle and direction of motion of the trailer 110 representing motion of the trailer 110 along a negative sloped surface (e.g., downhill); detect an acceleration of the trailer 110 representing an increase in velocity during downhill travel; and interpret a residual acceleration, not attributable to slope-induced effects, as an indication of propulsion or external force (e.g., motor output or trailer push from the tow vehicle).

In this implementation, during a particular time period, the controller can: detect an acceleration of the trailer 110 (e.g., via an accelerometer); and detect a decline angle of the trailer 110 (e.g., via a tilt sensor). The controller can then: estimate a passive acceleration component of motion of the trailer 110; and calculate a difference between the passive acceleration component and the actual acceleration detected by the accelerometer. Therefore, the controller can: interpret the difference between the passive acceleration component and the actual acceleration as a proxy for either active drive torque or towing-induced acceleration, and selectively modulate torque output, such as to reduce torque assistance when natural acceleration is sufficient.

### 17. Negative Sloped Surface: Driver Intent

Blocks of the method S100 recite: interpreting an intent at a tow vehicle, coupled to the trailer 110, in Block S140; and modulating torque output of the motor 130 based on the intent at the tow vehicle and proportional to the difference in Block S160. In one implementation, the controller can: detect an acceleration of the trailer 110 and a corresponding decline angle; calculate a difference between the passive acceleration component and the actual acceleration; interpret the difference to infer an intent at the tow vehicle; and adjust motor output accordingly, as shown in FIGS. 2, 7A, and 7B.

In one variation, in response to the acceleration exceeding the passive acceleration component, the controller can: interpret an intent at the tow vehicle to accelerate (e.g., apply torque output downhill); and increase torque output of the motor 130 proportional to the difference. In particular, the controller can: calculate a longitudinal force predicted to yield the observed difference based on an estimated weight of the trailer 110; calculate a target torque output based on the longitudinal force and the wheel radius; and increase motor 130 torque output according to the target torque.

In another variation, in response to the acceleration approximating the passive acceleration component, the controller can: interpret an intent at the tow vehicle to coast; and decrease torque output of the motor 130 toward null torque output and null braking torque output (e.g., idle or zero-torque mode), such that the trailer 110 descends without active propulsion or braking.

In yet another variation, in response to the acceleration falling below the passive acceleration component, the controller can: interpret an intent at the tow vehicle to brake; and increase regenerative braking of the motor 130 proportional to the difference between the passive acceleration component and the actual acceleration. Therefore, the controller can: detect a difference between the passive acceleration component and the actual acceleration of the trailer 110; identify whether the trailer 110 is actively accelerating, coasting, or decelerating beyond gravitational contribution; infer the intent at the tow vehicle; and selectively increase or reduce torque output (or regenerative braking output) to support the inferred intent during downhill travel.

### 18. Torque Output Modulation: Battery Charge State

In one variation, the controller can monitor the charge state of the battery assembly 140 coupled to the trailer 110 and selectively modulate torque output of the motor 130 based on the detected charge state. In particular, the controller can monitor the charge state of the battery assembly 140 coupled to the trailer 110 and trigger the motor 130 to selectively increase or reduce the torque output to the driven axle 120, in the direction of motion and proportional to the charge state of the battery assembly 140, in order to achieve the intent at the tow vehicle. Further, in response to the charge state exceeding or falling below a threshold charge state, the controller can trigger the motor 130: to increase torque output, in the direction of motion, to the driven axle 120 according to the maximum torque output; to increase torque output to the driven axle 120 incrementally over time toward the maximum torque output; or to disable torque output assist.

In another variation, in response to interpreting an intent at the tow vehicle to decelerate, the controller can: detect a charge state of the battery assembly 140 coupled to the trailer 110; and modulate (e.g., increase or decrease) regenerative braking output of the motor 130 inversely proportional to the charge state. For example, the controller can reduce regenerative braking output as the charge state of the battery approaches full charge or increase regenerative braking output when the charge state of the battery is relatively low.

In another variation, in response to interpreting an intent at the tow vehicle to decelerate, the controller can selectively enter regenerative braking mode based on the charge state of the battery (i.e., relative to a threshold charge state). In particular, in response to detecting a charge state of the battery assembly 140 exceeding a maximum charge threshold (e.g., 90%), the controller can disable regenerative braking mode; and select a coasting mode for the motor 130 to prevent further charging of the battery. Conversely, in response to detecting the charge state of the battery assembly 140 falling below the maximum charge threshold, the controller can trigger the motor 130 to increase regenerative braking to the driven axle 120. Therefore, the controller can: interpret the charge state of the battery assembly 140 in real time; and selectively modulate torque output of the motor 130 to balance energy recovery with charge constraints, while maintaining alignment with intent at the tow vehicle.

In another variation, in response to interpreting an intent of the driver to accelerate, the controller can selectively enter a drive suppression mode based on the charge state of the battery assembly 140 (i.e., relative to a minimum charge threshold). In particular, in response to detecting a charge state of the battery assembly 140 falling below a minimum charge threshold (e.g., 10%), the controller can disable torque output assist; and trigger the motor 130 to apply a low-level regenerative braking torque to the driven axle 120 in order to recover energy. Conversely, in response to detecting the charge state of the battery assembly 140 exceeding the minimum charge threshold, the controller can re-enable torque output assist in the direction of motion. Therefore, the controller can: interpret the charge state of the battery assembly 140 in real time; and selectively override driver intent to preserve battery function and recover energy during low-power conditions.

### 19. Torque Output Modulation: Brake Line Signal Verification

In one variation, the controller can access signals representing braking activity on the trailer 110 to verify intent at the tow vehicle prior to applying torque control. In particular, the controller can interpret a signal from a pressure sensor coupled to a brake line of the trailer 110 as indicative of a braking command issued by the driver of the tow vehicle. In this variation, the controller can: implement methods and techniques described above to interpret an intent at the tow vehicle to decelerate (i.e., brake); access the signal from the pressure sensor; and verify the intent at the tow vehicle to decelerate the trailer 110 based on the pressure detected within the brake line. More specifically, the controller can interpret a change in pressure within the brake line—as detected by the pressure sensor—as evidence of braking input from the driver.

In another variation, the controller can: implement methods and techniques described above to interpret an intent at the tow vehicle; access the signal from the brake line pressure sensor; detect a discrepancy between the predicted intent and real intent at the tow vehicle indicated by the brake line pressure; and override or suppress torque output assist in accordance with the real intent at the tow vehicle.

For example, the controller can: implement methods and techniques described above to interpret an intent at the tow vehicle to accelerate (e.g., based on motion and slope conditions); and access the signal from the brake line pressure sensor. In this variation, the controller can: detect a discrepancy between predicted intent to accelerate and elevated brake line pressure in response to detecting elevated brake pressure while interpreting an intent at the tow vehicle to accelerate; and override or suppress torque output assist (e.g., to avoid applying forward torque while braking input is detected).

In another example, the controller can: implement methods and techniques described above to interpret an intent at the tow vehicle to decelerate; detect a change in brake line pressure in the brake line of the trailer; and, in response to interpreting the intent at the tow vehicle to decelerate and in response to detecting the change in brake line pressure, increase regenerative braking of the motor proportional to the change in brake line pressure.

The controller can then implement methods and techniques described above to: continue monitoring the signal from the brake line and interpreting the intent at the tow vehicle; and, in response to verifying alignment between the brake line pressure and the intent at the tow vehicle, modulate torque output of the motor 130 in accordance with the intent at the tow vehicle. Thus, in this variation, the controller can validate a predicted intent at the tow vehicle by leveraging pressure signals from the trailer brake line and apply or withhold torque output accordingly.

### 20. Torque Output Modulation: Efficiency During Downhill Acceleration

In one variation, the controller can selectively reduce torque output of the motor 130 during downhill motion to improve energy efficiency and avoid unnecessary torque contribution. In particular, the controller can interpret downhill motion of the trailer 110 and minimize active propulsion effort, such as when gravitational force is sufficient to sustain or increase trailer speed. In this variation, the controller can: implement methods and techniques described above to detect a decline angle of the trailer 110 (e.g., via a tilt sensor); detect an acceleration of the trailer 110 (e.g., via an accelerometer); and interpret an intent at a tow vehicle to accelerate while traversing a downhill slope. The controller can then: access a weight of the trailer 110 (e.g., from prior estimation based on suspension pressure or calibration torque response); and calculate a target torque output predicted to yield the observed difference between a passive acceleration component (e.g., attributable to gravitational force along the decline) and the measured acceleration.

In particular, the controller can estimate the passive acceleration of the trailer 110 based on the decline angle and trailer weight; and interpret a difference between the passive acceleration and the actual acceleration as an indication that the motor 130 is contributing to additional acceleration during downhill motion. In response to the target torque output falling below a threshold torque output (e.g., indicating that gravitational force is sufficient to sustain motion without active torque), the controller can select a coasting mode for the motor 130 and/or decrease torque output of the motor 130 toward null torque output and null braking torque output. Therefore, the controller can: interpret downhill motion conditions to identify when torque output is unnecessary; and selectively reduce or suspend torque contribution from the motor 130 to improve energy efficiency, avoid over-speed conditions, and prolong battery life without compromising trailer stability or motion continuity.

### 21. Slip Ratio Limit

In one variation, as shown in FIGS. 3, 4, and 6, the controller can: select or set a fixed or dynamic slip ratio limit for the trailer 110 (i.e., a ratio of the linearized angular velocity of a wheel on the trailer 110 relative to the actual longitudinal linear velocity of the trailer body), such as based on current conditions or derived from recent motion of the trailer 110; and actively limit maximum torque output and maximum braking (maximum input torque from regenerative braking) by the driven axle 120 in order to remain below this slip ratio limit in nominal operation conditions and/or to achieve this slip ratio limit at the driven axle 120 in emergency conditions (e.g., to support the tow vehicle in ascending a steep hill via torque output by the driven axle 120, or to right the tow vehicle under a trailer rollover condition or jackknife condition via regenerative braking of the driven axle 120).

In particular, the controller can select or set a fixed or dynamic slip ratio limit that represents slippage of wheels of the driven axle 120 under a torque output that yields approximately maximum forward acceleration of the trailer 110 for the given road condition such that further torque output by the driven axle 120 increases wheel slip, resulting in: loss of traction, less forward acceleration, and an increased real slip ratio for the trailer 110; and less torque output by the driven axle 120 decreasing wheel slip, decreasing forward acceleration, and decreasing the real slip ratio.

Similarly, the controller can select or set a fixed or dynamic slip ratio limit, which represents slippage of wheels of the driven axle 120 under braking (e.g., regenerative braking) that yields approximately maximum rearward acceleration (i.e., braking) of the trailer 110 for the given road condition such that: further braking by the driven axle 120 increases wheel slip, resulting in loss of traction, less rearward acceleration (i.e., less braking effect), and an increased real slip ratio for the trailer 110; and less braking by the driven axle 120 decreases wheel slip, decreases rearward acceleration (i.e., decreases braking effect), and decreases the real slip ratio resulting in increased traction on the driven axle 120.

In one implementation, the controller can select or set a fixed slip ratio limit for the trailer 110 (e.g., independent from the ground surface conditions and/or load conditions of the trailer 110). For example, under nominal conditions such as normal road friction, steady-state towing, and moderate load distribution, the controller can select a fixed slip ratio limit of 0.0, indicating that the actual ground speed of the trailer 110 is equivalent to the wheel speed. In another example, during acceleration, the controller can select a fixed slip ratio limit of 0.10 (or 10%), indicating that the wheel surface is rotating 10% faster than the actual ground speed of the trailer 110. In yet another example, during regenerative braking, the controller can select a fixed slip ratio limit of −0.10 (or −10%), indicating that the wheel surface is rotating 10% slower than the actual ground speed of the trailer 110.

In one implementation, during operation, the controller can: derive a longitudinal linear speed (i.e., a ground speed) of the trailer 110 based on inertial signals output by the inertial sensor (e.g., an IMU) such as via dead reckoning, or based on geospatial positions of the trailer 110 over time; derive concurrent wheel speeds at the driven axle 120 wheel based on signals output by a wheel speed sensor or speed of the motor 130 in the driven axle 120; and derive a current real slip ratio of the trailer 110 based on the longitudinal linear speed and the wheel speed.

### 21.1 Maintaining Target Slip Ratio During Acceleration

In one implementation, during acceleration, the controller can selectively decrease torque output by the driven axle 120 in response to detecting the real slip ratio exceeding a threshold slip ratio, the threshold slip ratio based on the slip ratio limit. For example, during acceleration, the controller can: select a fixed slip ratio limit of 0.10 (or 10%); and trigger the motor 130 to decrease torque output in response to detecting the real slip ratio exceeding a threshold slip ratio of 0.05 (or 5%).

In particular, in response to the real slip ratio exceeding the threshold slip ratio, the controller can derive a target torque output, in the direction of motion, predicted to yield a real slip ratio below the threshold slip ratio. The controller can then: access a real torque output (e.g., a current torque output), in the direction of motion of the driven axle 120, during the time period; calculate a difference between the real torque output and the target torque output; set a maximum torque output by the driven axle 120 based on the difference between the real torque output and the target torque output; and trigger the motor 130 to decrease torque output in the direction of motion toward the maximum torque output.

In one example, when the trailer 110 is traversing an inclined ground surface (i.e., while in motion), the controller can selectively adjust torque output by the driven axle 120 to assist in accelerating the trailer 110 uphill while maintaining the real slip ratio below the slip ratio limit. For example, when the trailer 110 is traversing an inclined ground surface, the controller can: select a fixed slip ratio limit of 0.1 during acceleration; and trigger the motor 130 to increase torque output in response to detecting the real slip ratio falling below a threshold slip ratio of 0.05, thereby ensuring sufficient traction to initiate movement without excessive wheel slip. The controller can then implement methods and techniques described above to trigger the motor 130 to increase torque output in the direction of motion toward the target torque output.

### 21.2 Maintaining Target Slip Ratio During Deceleration

In one variation, Blocks of the method S100 recite: detecting a linear speed of the trailer 110 in Block S190; detecting a wheel speed of a first wheel of the trailer 110 in Block S192; calculating a real slip ratio of the trailer 110 based on the linear speed of the trailer 110 and the wheel speed of the first wheel in Block S194; in response to the first real slip ratio falling below the target slip ratio limit, setting a regenerative braking limit, less than an initial regenerative braking limit, at the driven axle 120 based on the target slip ratio limit in Block S130; and decreasing regenerative braking of the motor 130 toward the second regenerative braking limit in Block S160.

In one variation, during regenerative braking, the controller can selectively decrease the regenerative braking output by the driven axle 120 in response to detecting the real slip ratio falling below a threshold slip ratio to maintain sufficient braking force while preventing excessive grip that may reduce braking effectiveness. For example, during regenerative braking, the controller can: select a fixed slip ratio limit of −0.10 (or −10%); and trigger the motor 130 to decrease the regenerative braking output in response to detecting the real slip ratio falling below a threshold slip ratio of −0.05 (or −5%).

In particular, during a first time period, the controller can: implement methods and techniques described above to interpret an intent at a tow vehicle to decelerate; set a first regenerative braking limit for the motor 130 based on a target slip ratio limit for regenerative braking; and increase regenerative braking of the motor 130 toward the first regenerative braking limit to maintain a real slip ratio of the trailer 110 below the target slip ratio limit. The controller can then, during a second time period succeeding the first time period: detect a linear speed of the trailer 110; and detect a wheel speed of a first wheel of the trailer 110. The controller can then calculate a real slip ratio of the trailer 110 based on the linear speed of the trailer 110 and the wheel speed of the first wheel. In response to the real slip ratio falling below the target slip ratio limit, the controller can: set a second regenerative braking limit, less than the first regenerative braking limit; and trigger the motor 130 to decrease regenerative braking toward the second regenerative braking limit.

In one variation, in response to the real slip ratio falling below the threshold slip ratio, the controller can derive a target regenerative braking torque, in the direction opposite to motion, predicted to increase the real slip ratio. The controller can then: access a real regenerative braking output (e.g., a current regenerative torque output), in the direction opposite to motion, of the driven axle 120 during the time period; calculate a difference between the real regenerative braking output and the target regenerative braking output; set a maximum regenerative braking output by the driven axle 120 based on the difference between the real regenerative braking output and the target regenerative braking output; and trigger the motor 130 to decrease regenerative braking torque in the direction opposite to motion toward the maximum regenerative braking output.

Accordingly, the controller can modulate torque output during acceleration and regenerative braking torque during deceleration to maintain the slip ratio within predefined limits, thereby ensuring sufficient traction while preventing excessive slip or wheel lockup. By dynamically adjusting torque output, the controller maintains traction across varying surface conditions and load distributions, thereby enhancing trailer stability and energy efficiency, along with reducing tire wear.

### 22. Emergency Conditions

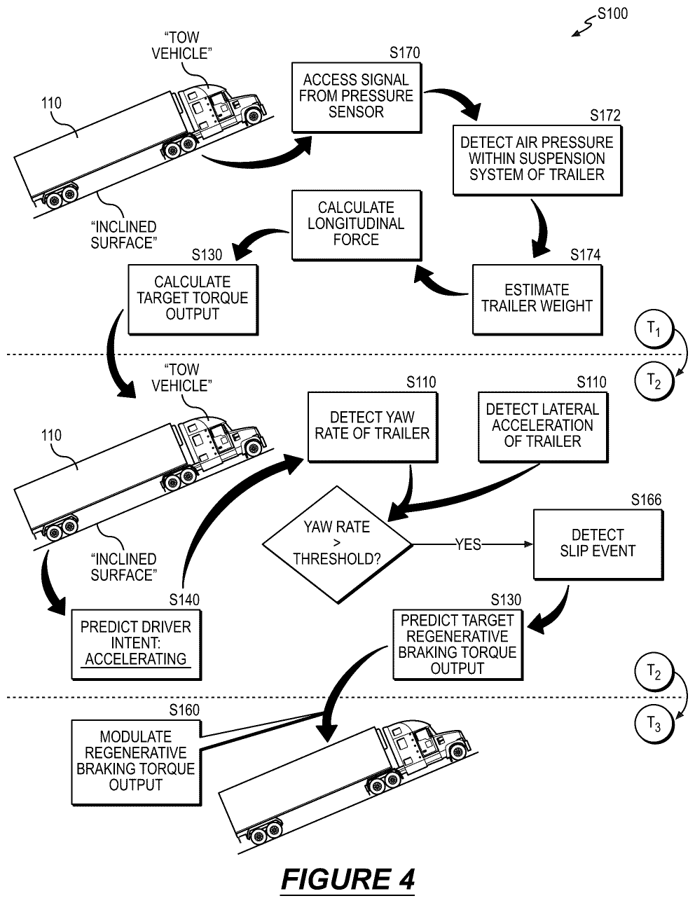

In one variation, as shown in FIG. 4, Blocks of the method S100 recite: detecting a yaw rate of the trailer 110; detecting a lateral acceleration of the trailer 110 in Block S110; and, in response to detecting the first yaw rate exceeding a threshold rate defined for the first lateral acceleration, detecting a slip event at the trailer 110 in Block S166. In this variation, Blocks of the method S100 also recite, in response to detecting the slip event: estimating a target regenerative braking output by the drive system to maintain a coupler between the trailer 110 and the tow vehicle in tension in Block S130; and increasing regenerative braking of the motor 130 toward the target regenerative braking output in Block S160.

In one variation, the controller can: detect presence of unstable trailer conditions (e.g., lateral slipping, high lateral acceleration, high yaw rate, trailer sway, a tow vehicle jackknife condition, a wheel flare); and adjust torque output (or regenerative braking output) to stabilize the trailer 110. In this variation, the controller can: access a first signal output by the IMU sensor and representing a lateral acceleration of the trailer 110 during a time period; access a second signal output by the IMU sensor and representing a rate of rotational change of the trailer 110 relative to the direction of motion (or a “yaw rate”) during the time period; and interpret the first signal and the second signal to detect a lateral slip event. For example, the controller can detect a lateral slip event (i.e., an instability condition) in response to detecting: the yaw rate exceeding a predefined threshold based on the lateral acceleration, thus indicating a loss of lateral traction (e.g., corresponding to a possible oversteering maneuver or a jackknife condition); a delay between the yaw rate and the lateral acceleration, thus indicating a delayed lateral force response (e.g., corresponding to uncontrolled sliding rather than normal wheel grip); etc. In response to detecting the lateral slip event, the controller can: select a regenerative braking mode for the motor 130; estimate a target regenerative braking output that maintains forward tension between the trailer 110 and the tow vehicle; and increase regenerative braking of the motor 130 toward the target regenerative braking output.

In one variation, the controller can: estimate a first deceleration rate of the tow vehicle based on a third signal output by the IMU sensor and representing a longitudinal deceleration of the trailer 110 in the direction of motion; derive a second deceleration rate, greater than (i.e., a higher magnitude than) the first deceleration rate, predicted to maintain tension between the tow vehicle and the trailer 110 (e.g., to reduce the risk of trailer instability or a jackknife condition) while maintaining the real slip ratio within a target slip ratio range (e.g., between 0.9 and 0.95); set a maximum regenerative braking output by the driven axle 120 based on the second deceleration rate; and trigger the motor 130 to decrease the regenerative braking output opposite the direction of motion toward the maximum regenerative braking output. Accordingly, without communications between the tow vehicle and trailer 110, the controller can: detect presence of an instability condition; and trigger the motor 130 to apply controlled regenerative braking to stabilize the trailer 110.

In one variation, the controller can automatically trigger the motor 130 from coasting mode to regenerative braking mode in response to detecting a slip event, even if regenerative braking is initially disabled due to battery charge constraints. For example, prior to detection of the slip event, the driver may attempt to decelerate while the charge state of the battery exceeds a maximum threshold (e.g., 90%). In this example, the controller can: implement methods and techniques described above to interpret the intent at the tow vehicle to decelerate; detect the charge state of the battery assembly 140 coupled to the trailer 110; and, in response to the charge state exceeding the threshold, select the coasting mode to prevent overcharging. Then, upon detecting a lateral slip event, the controller can: override the coasting mode; select a regenerative braking mode for the motor 130; estimate a target regenerative braking output based on trailer weight and motion; and increase regenerative braking of the motor 130 toward the target regenerative braking output. Accordingly, without requiring direct communication between the tow vehicle and trailer 110, the controller can: detect presence of an instability condition based on trailer kinematics; override prior torque control constraints based on battery conditions; and trigger regenerative braking to actively stabilize the trailer 110 and maintain directional tension between the trailer 110 and the tow vehicle.

### 22.1 Wheel Flares

In one variation, the controller can detect an instability condition based on relative speeds of the wheels and the trailer 110. In this variation, the controller can detect a wheel slip event (or a “wheel flare”) in response to detecting a difference between the wheel speed and the trailer speed exceeding a predefined threshold. Alternatively, the controller can detect a wheel slip event in response to detecting variations in wheel speeds of the wheels of the trailer 110 (e.g., indicating uneven traction distribution, or rapid loss of wheel grip). In particular, the controller can detect wheel slip events at each wheel of the trailer 110 including: driven wheels of the driven axle 120; and/or passive wheels of the passive axle.

The controller can then implement methods and techniques described above to trigger the motor 130 to decrease torque output in the direction of motion (i.e., to stabilize the trailer 110). In one example, the controller can trigger the motor 130 to decrease torque output in response to detecting a quantity of wheel slip events exceeding a threshold quantity within a predefined time period.

### 23. Override Mode

In one variation, the controller can implement methods and techniques described above to: interpret an intent at a tow vehicle, coupled to the trailer 110, to accelerate the tow vehicle; detect presence of an instability condition (e.g., a lateral slip event, a wheel flare); and trigger the motor 130 to decrease the torque output in the direction of motion in response to detecting the instability condition to prevent the real slip ratio from exceeding the slip ratio limit.

In another variation, the controller can implement methods and techniques described above to: interpret an intent at a tow vehicle, coupled to the trailer 110, to accelerate the tow vehicle; detect presence of an instability condition; and override the predicted intent at the tow vehicle to accelerate. In particular, the controller can increase regenerative braking of the motor 130 toward a target regenerative braking output, predicted to maintain longitudinal control and prevent the real slip ratio from exceeding the slip ratio limit.

In another variation, the controller can implement methods and techniques described above to: interpret an intent at the tow vehicle to decelerate the tow vehicle; detect presence of an instability condition; and trigger the motor 130 to increase the regenerative braking output opposite the direction of motion in response to detecting the instability condition and in response to the real slip ratio falling below the slip ratio limit. Thus, the controller can override an inferred intent at the tow vehicle (e.g., to accelerate) to maintain stability of the trailer 110.

### 23.1 Variation: Dynamic Slip Ratio Limit Based on Surface Conditions+Load Conditions

In one variation, Blocks of the method S100 recite: detecting a ground surface condition of a ground surface traversed by the trailer 110 in Block S112; accessing a second signal from a pressure sensor coupled to the drive system in Block S170; detecting an air pressure within a pneumatic suspension system supporting the drive system based on the second signal in Block S172; interpreting a load of the trailer 110 carried by the drive system based on the air pressure within the pneumatic suspension system in Block S174; and setting a target slip ratio limit for the trailer 110 based on the ground surface condition and the load of the trailer 110 in Block S188.

In one variation, the controller can: detect surface conditions (e.g., surface texture, friction coefficient) of a ground surface as the trailer 110 traverses the ground surface; detect load conditions (e.g., trailer weight, load weight, load distribution) of the trailer 110; and derive a dynamic slip ratio limit for the trailer 110 based on the surface conditions and/or load conditions. In particular, the controller can derive the dynamic slip ratio limit based on: surface conditions of the ground surface, such as surface type (e.g., asphalt, gravel), surface texture (e.g., dry, wet, icy), etc.; and/or load conditions, such as a trailer weight, a load distribution (e.g., concentrated near the front vs. evenly distributed across the trailer 110), a longitudinal position of the chassis, etc.

In this variation, the controller can: access a first image from an optical sensor arranged on the trailer 110; and detect a ground surface condition of a ground surface traversed by the trailer 110 based on the first image. Additionally or alternatively, the controller can: access a second signal from a pressure sensor coupled to the drive system; detect an air pressure within a pneumatic suspension system supporting the drive system based on the second signal; and interpret a load of the trailer 110 carried by the drive system based on the air pressure within the pneumatic suspension system. The controller can then set a target slip ratio limit for the trailer 110 based on the ground surface condition and/or the load of the trailer 110. Furthermore, the controller can selectively modulate torque output of the motor 130 based on the target slip ratio. For example, the controller can: set a torque output limit for the motor 130 based on the target slip ratio limit for regenerative braking; and modulate torque output of the motor 130 toward the torque output limit.

For example, the controller can derive a first slip ratio limit of 0.05 (e.g., representing allowable slip for maintaining control on low-friction surfaces) for an unloaded trailer 110 traversing an icy, asphalt surface. Alternatively, the controller can derive a second slip ratio limit of 0.1 (e.g., representing allowable slip for maximizing traction on high-friction, loose surfaces) for a loaded trailer 110 traversing a dry, gravel surface.

In one variation, the controller can implement methods and techniques described above to interpret signals output by the set of sensors arranged on the trailer 110 to detect surface conditions of the ground surface and/or load conditions of the trailer 110. For example, the controller can implement methods and techniques described above to: detect an instability condition (e.g., a lateral slip event, a wheel slip event); and interpret a surface condition of the ground surface based on the instability condition. The controller can then repeat this process to adapt the slip ratio limit in real-time as the trailer 110 encounters varying surface conditions while in motion.

### 24. Variation: Dynamic Slip Ratio Limit Based on Perceived Maneuver

In one variation, during operation, the controller can: interpret a maneuver of the tow vehicle (e.g., based on IMU sensor data); and derive a dynamic slip ratio limit for the trailer 110 based on the interpreted maneuver. In particular, the controller can increase or decrease the slip ratio limit to distribute traction over longitudinal and lateral forces based on the interpreted maneuver. For example, during longitudinal force-dominant maneuvers (e.g., high-force acceleration or heavy braking), the controller can increase the slip ratio limit (e.g., from 0.05 to 0.1) to maximize longitudinal force transfer from the wheel-road interface. Conversely, during lateral force-sensitive maneuvers (e.g., sharp turns, evasive steering corrections), the controller can decrease the slip ratio limit (e.g., from 0.05 to 0.02) to preserve lateral grip.

Accordingly, the controller can dynamically adjust the slip ratio limit in response to both immediate instability events and general stability control requirements. More specifically, independent of emergency conditions, the controller can reduce torque output to allocate wheel grip to lateral stability, thereby preventing instability prior to encountering excessive slip.

### 25. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for autonomously controlling torque output of a trailer pulled by a tow vehicle, the method comprising:
during a first time period:
detecting a first deceleration of the trailer; and
detecting a first incline angle of the trailer;
estimating a first passive deceleration component of the first deceleration based on the first incline angle;
calculating a first difference between the first passive deceleration component and the first deceleration; and
modulating torque output of a motor, arranged in a drive system of the trailer, proportional to the first difference.

2. The method of claim 1:
wherein modulating torque output of the motor proportional to the first difference comprises:
in response to the first deceleration approximating the first passive deceleration component:
interpreting an intent at the tow vehicle, coupled to the trailer, to coast; and
in response to interpreting the intent at the tow vehicle to coast:
decreasing torque output of the motor toward null torque output and null regenerative braking, the motor coupled to a driven axle of a bogie of the trailer, the drive system of the trailer comprising the motor, the driven axle, and the bogie; and
further comprising:
during a second time period:
detecting a second deceleration of the trailer; and
detecting a second incline angle of the trailer;
estimating a second passive deceleration component of the second deceleration based on the second incline angle;
in response to the second deceleration exceeding the second passive deceleration component:
interpreting an intent at the tow vehicle to decelerate; and
in response to interpreting the intent at the tow vehicle to decelerate:
increasing regenerative braking of the motor proportional to a second difference between the second passive deceleration component and the second deceleration.

3. The method of claim 2:
further comprising during the first time period:
detecting absence of a first change in brake line pressure in a brake line of the trailer;
wherein modulating torque output of the motor proportional to the first difference comprises:
in response to interpreting the intent at the tow vehicle to coast and in response to detecting absence of the first change in brake line pressure:
decreasing torque output of the motor toward null torque output and null regenerative braking;
further comprising during the second time period:
detecting a second change in brake line pressure in the brake line of the trailer; and
wherein increasing regenerative braking of the motor proportional to the second difference between the second passive deceleration component and the second deceleration comprises:
in response to interpreting the intent at the tow vehicle to decelerate and in response to detecting the second change in brake line pressure:
increasing regenerative braking of the motor proportional to the second change in brake line pressure.

4. The method of claim 1, wherein modulating torque output of the motor proportional to the first difference comprises:
in response to the first deceleration exceeding the first passive deceleration component:
interpreting an intent at a tow vehicle, coupled to the trailer, to decelerate; and
in response to interpreting the intent at the tow vehicle to decelerate:
detecting a first charge state of a battery arranged on the trailer and electrically coupled to the motor; and
increasing regenerative braking of the motor inversely proportional to the first charge state, the motor coupled to a driven axle of a bogie of the trailer, the drive system of the trailer comprising the motor, the driven axle, and the bogie.

5. The method of claim 1:
further comprising, during a calibration period:
triggering the motor to output a calibration torque while the trailer travels at a constant speed on flat ground;
detecting an acceleration of the trailer responsive to output of the calibration torque by the drive system of the trailer; and
estimating a weight of the tow vehicle and the trailer based on:
the calibration torque; and
the acceleration of the trailer; and
wherein modulating torque output of the motor proportional to the first difference comprises:
modulating torque output of the motor proportional to the first difference and proportional to the weight of the tow vehicle and the trailer, the motor coupled to a driven axle of a bogie of the trailer, the drive system of the trailer comprising the motor, the driven axle, and the bogie.

6. The method of claim 1:
further comprising:
detecting an air pressure within a pneumatic suspension system supporting the drive system of the trailer based a signal output by a pressure sensor coupled to the drive system of the trailer; and
estimating a weight of the trailer based on:
the air pressure; and
a weight distribution scalar representing a proportion of weight of the. trailer supported by the pneumatic suspension system; and
wherein modulating torque output of the motor proportional to the first difference comprises:
calculating a target torque output of the motor based on the weight of the trailer; and
modulating torque output of the motor according to the target torque output, the motor coupled to a driven axle of a bogie of the trailer, the drive system of the trailer comprising the motor, the driven axle, and the bogie.

7. The method of claim 1, wherein modulating torque output of the motor proportional to the first difference comprises:
in response to the first passive deceleration component exceeding the first deceleration:
interpreting an intent at the tow vehicle, coupled to the trailer, to accelerate; and
in response to interpreting the intent at the tow vehicle to accelerate:
increasing torque output of the motor proportional to the first difference, the motor coupled to a driven axle of a bogie of the trailer, the drive system of the trailer comprising the motor, the driven axle, and the bogie.

8. The method of claim 1, further comprising:
during a second time period:
detecting a second acceleration of the trailer; and
detecting a second decline angle of the trailer;
estimating a second passive acceleration component of the second acceleration based on the second decline angle;
calculating a second difference between the second passive acceleration component and the second acceleration; and
modulating torque output of the motor proportional to the second difference, the motor coupled to a driven axle of a bogie of the trailer, the drive system of the trailer comprising the motor, the driven axle, and the bogie.

9. The method of claim 8, wherein modulating torque output of the motor proportional to the second difference comprises:
in response to the second acceleration exceeding the second passive acceleration component:
interpreting an intent at the tow vehicle, coupled to the trailer, to accelerate; and
in response to interpreting the intent at the tow vehicle to accelerate:
increasing torque output of the motor proportional to the second difference.

10. The method of claim 8, wherein modulating torque output of the motor proportional to the second difference comprises:
in response to the second acceleration approximating the second passive acceleration component:
interpreting an intent at a tow vehicle, coupled to the trailer, to coast; and
in response to interpreting the intent at the tow vehicle to coast:
decreasing torque output of the motor toward null torque output and null regenerative braking.

11. The method of claim 1, wherein modulating torque output of the motor proportional to the first difference comprises:
in response to the first deceleration exceeding the first passive deceleration component:
interpreting an intent at a tow vehicle, coupled to the trailer, to decelerate; and
in response to interpreting the intent at the tow vehicle to decelerate:
setting a first regenerative braking limit for the motor based on a target slip ratio limit for regenerative braking; and
modulating torque output of the motor toward the first regenerative braking limit, the motor coupled to a driven axle of a bogie of the trailer, the drive system of the trailer comprising the motor, the driven axle, and the bogie.

12. The method of claim 11, further comprising:
during a second time period succeeding the first time period:
detecting a linear speed of the trailer; and
detecting a wheel speed of a wheel of the trailer;
calculating a real slip ratio of the trailer based on the linear speed of the trailer and the wheel speed of the wheel; and
in response to the real slip ratio falling below the target slip ratio limit:
setting a second regenerative braking limit, less than the first regenerative braking limit, based on the target slip ratio limit; and
decreasing regenerative braking of the motor toward the second regenerative braking limit.

13. The method of claim 1:
further comprising:
during the first time period:
detecting a first yaw rate of the trailer; and
detecting a first lateral acceleration of the trailer; and
in response to the first yaw rate exceeding a range defined for the first lateral acceleration, detecting a slip event at the trailer; and
wherein modulating output of the motor proportional to the first difference comprises:
in response to detecting the slip event:
estimating a target regenerative braking output by the drive system to maintain a coupler between the trailer and the tow vehicle in tension; and
increasing a regenerative braking output of the motor toward the target regenerative braking output, the motor coupled to a driven axle of a bogie of the trailer, the drive system of the trailer comprising the motor, the driven axle, and the bogie.

14. The method of claim 13, wherein modulating torque output of the motor proportional to the first difference comprises:
in response to the first passive deceleration component exceeding the first deceleration:
interpreting an intent at the tow vehicle to accelerate; and
in response to detecting the slip event:
overriding the intent at the tow vehicle to accelerate; and
increasing regenerative braking of the motor toward the target regenerative braking output.

15. A method for autonomously controlling torque output of a trailer pulled by a tow vehicle, the method comprising:
detecting an acceleration of the trailer traveling at a decline angle;
estimating a passive acceleration component of the acceleration based on the decline angle;
calculating a difference between the passive acceleration component and the acceleration;
interpreting an intent at a tow vehicle, coupled to the trailer, based on the difference; and
modulating torque output of a motor, arranged in a drive system of the trailer of the trailer, according to the intent at the tow vehicle and proportional to the difference.

16. The method of claim 15:
wherein interpreting the intent at the tow vehicle comprises:
in response to the passive acceleration component exceeding the acceleration, interpreting the intent at the tow vehicle to decelerate; and
wherein modulating torque output of the motor comprises:
in response to interpreting the intent at the tow vehicle to decelerate:
detecting a charge state of a battery arranged on the trailer and electrically coupled to the motor; and
in response to the charge state of the battery exceeding a threshold charge state, decreasing regenerative braking of the motor toward null torque output and null regenerative braking, the motor coupled to a driven axle of a bogie of the trailer, the drive system of the trailer comprising the motor, the driven axle, and the bogie.

17. The method of claim 16, further comprising:
detecting a yaw rate of the trailer;
detecting a lateral acceleration of the trailer;
in response to the yaw rate exceeding a range defined for the lateral acceleration, detecting a slip event; and
in response to detecting the slip event:
estimating a target regenerative braking output to maintain tension between the trailer and a tow vehicle coupled to the trailer; and
increasing regenerative braking of the motor toward the target regenerative braking output.

18. The method of claim 15:
further comprising:
accessing a first image captured by an optical sensor arranged on the trailer;
detecting a ground surface condition of a ground surface traversed by the trailer based on the first image;
accessing a second signal from a pressure sensor coupled to the drive system of the trailer;
detecting an air pressure within a pneumatic suspension system supporting the drive system of the trailer based on the second signal; and
interpreting a load of the trailer carried by the drive system of the trailer based on the air pressure within the pneumatic suspension system; and
wherein modulating torque output of the motor comprises:
setting a target slip ratio limit for the trailer based on:
the ground surface condition; and
the load of the trailer;
setting a torque output limit for the motor based on the target slip ratio limit; and
modulating torque output of the motor toward the torque output limit, the motor coupled to a driven axle of a bogie of the trailer, the drive system of the trailer comprising the motor, the driven axle, and the bogie.

19. The method of claim 15:
wherein interpreting the intent at the tow vehicle comprises:
in response to the acceleration exceeding the passive acceleration component, interpreting the intent at the tow vehicle to accelerate; and
wherein modulating torque output of the motor comprises:
accessing a weight of the trailer;
calculating a target torque output predicted to yield the difference between the passive acceleration component and the acceleration based on the weight of the trailer; and
in response to the target torque output falling below a threshold torque output, decreasing torque output of the motor toward null torque output and null regenerative braking, the motor coupled to a driven axle of a bogie of the trailer, the drive system of the trailer comprising the motor, the driven axle, and the bogie.

20. A system comprising:
a driven axle configured to install on a trailer;
a motor coupled to the driven axle and configured to:
output torque to the driven axle; and
regeneratively brake the driven axle;
a battery assembly configured to:
install on the trailer;
supply electrical energy to the motor to drive the driven axle; and
receive electrical energy from the motor during regenerative braking of the driven axle by the motor; and
a controller configured to:
detect a deceleration of the trailer;
detect an incline angle of the trailer;
predict a passive deceleration component of the deceleration based on the incline angle;
calculate a difference between the passive deceleration component and the deceleration; and
modulate torque output of the motor proportional to the difference.
